(19) United States
(12) Patent Application Publication
(10) Pub. No.: US 2024/0286720 A1
(43) Pub. Date: Aug. 29, 2024

(54) AUTOMATIC CAMERA REGISTRATION AND CALIBRATION USING MARINE SENSORS

(71) Applicant: Orca AI Ltd., Tel Aviv (IL)

(72) Inventors: Dor RAVIV, Tel Aviv (IL); Yonathan NATIV, Tel Aviv (IL); Anton YURKOV, Ramat Gan (IL)

(21) Appl. No.: 18/572,890

(22) PCT Filed: Jun. 21, 2022
(86) PCT No.: PCT/IL2022/050665

§ 371 Date: Dec. 21, 2023

(30) Foreign Application Priority Data
Jun. 21, 2021 (IL) 284251

(51) Int. Cl. B63B 49/00; G06T 7/80

(52) U.S. Cl. CPC B63B 49/00; G06T 7/80; G06T 2207/30244

(57) ABSTRACT

A method including by a processor and memory circuitry
obtaining first position data informative of a position of first marine objects. The first position data can be obtained based on images acquired by at least one imaging device of a marine vessel,

The method can include obtaining second position data informative of a position of second marine objects,
wherein the second position data is obtained based on data acquired by at least one sensor of the marine vessel, At least one sensor can be different from the imaging device,
wherein at least some of the first marine objects are the same as some of the second marine object. The method can include
   using the first position data and the second position data to estimate data informative of at least a variable height and a variable orientation of at least one imaging device of the marine vessel.

### CROSS-REFERENCE TO A RELATED APPLICATION

This application is a national phase filing under 35 C.F.R. § 371 of and claims priority to PCT Patent Application No. PCT/IL2022/050665, filed on Jun. 21, 2022, which claims the priority benefit under 35 U.S.C. § 119 of Israeli Patent Application No. 284251, filed on Jun. 21, 2021, the contents of each of which are hereby incorporated in their entireties by reference.

### TECHNICAL FIELD

The presently disclosed subject matter relates to the field of marine environment.

### BACKGROUND

In the marine environment, a marine vessel travels on a route on which it can encounter various situations. Some of these situations can include dangers, e.g. an obstacle to be avoided, zones with dangerous weather, etc.

It is now necessary to provide new methods and systems in order to improve safety and reliability of marine vessels navigation, improve understanding of the marine environment for marine vessels and improve control of marine vessels. More generally, it is necessary to develop innovative methods in the marine domain, and in particular, in the field of autonomous ships.

### GENERAL DESCRIPTION

In accordance with certain aspects of the presently disclosed subject matter, there is provided a method comprising, by a processor and memory circuitry (PMC), estimating data informative of at least one of a height or an orientation of at least one imaging device of a marine vessel (that it to say data informative of a height and/or an orientation of the at least one imaging device of the marine vessel), wherein at least one of the height or the orientation (that it to say the height and/or the orientation) of the at least one imaging device is variable over time, the estimating comprising obtaining first position data informative of a position of first marine objects, wherein the first position data is obtained based on images acquired by the at least one imaging device of the marine vessel, obtaining second position data informative of a position of second marine objects, wherein the second position data is obtained based on data acquired by at least one sensor of the marine vessel, wherein the at least one sensor is different from the imaging device, wherein at least some of the first marine objects are the same as at least some of the second marine objects, and using the first position data and the second position data to estimate data informative of at least one of a height or an orientation of the at least one imaging device of the marine vessel.

In addition to the above features, the method according to this aspect of the presently disclosed subject matter can optionally comprise one or more of features (i) to (xxviii) below, in any technically possible combination or permutation:
i. the orientation comprises at least one of roll, pitch and yaw of the at least one imaging device, wherein the method comprises estimating at least one of roll, pitch and yaw of the at least one imaging device over time;
ii. the method comprises estimating data informative of at least one of a height or an orientation of the at least one imaging device at a first period of time, to obtain first estimated data, and estimating data informative of at least one of a height or an orientation of the at least one imaging device at a second period of time, different from the first period of time, using the first estimated data;
iii. the method comprises estimating data informative of at least one of a height or an orientation of the at least one imaging device at a first period of time, said estimating comprising determining an association between at least some of the first marine objects and at least some of the second marine objects, and estimating data informative of at least one of a height or an orientation of the at least one imaging device at a second period of time, different from the first period of time, using said association;
iv. the method comprises (1) obtaining first position data informative of a position of first marine objects FIRSTMOBJ_{1,i} to FIRSTMOBJ_{N,i} at a first period of time T_{1,i}, wherein the first position data is obtained based on images acquired by the least one imaging device of the marine vessel, (2) obtaining second position data informative of a position of second marine objects SNDMOBJ_{1,i} to SNDMOBJ_{M,i} at a second period of time T_{2,i}, wherein the first period of time T_{1,i} and the second period of time T_{2,i} meet a synchronization criterion, wherein the second position data is obtained based on data acquired by the at least one sensor of the marine vessel, wherein at least some of the first marine objects FIRSTMOBJ_{1,i} to FIRSTMOBJ_{N,i} are the same as at least some of the second marine objects SNDMOBJ_{1,i} to SNDMOBJ_{M,i}, (3) using the first position data and the second position data to estimate data informative of at least one of a height or an orientation of the at least one imaging device of the marine vessel, and (4) repeating at least once (1), (2) and (3) for i incremented by one, wherein a first period of time T_{1,i+1} differs from T_{1,i} and a second period of time T_{1,i+1} differs from T_{2,i}, for repetitively estimating data informative of at least one of a height or an orientation of the imaging device of the marine vessel over time;
v. the at least one sensor is not an imaging device;
vi. the at least one sensor includes at least one of a radar and an automatic identification system (AIS);
vii. the at least one sensor includes a first sensor and a second sensor, wherein the second sensor is of a different type than the first sensor, and wherein the first sensor and the second sensor are not imaging devices;
viii. using the first position data and the second position data comprises determining data D_{camera} informative of at least one of a height or an orientation of the imaging device which optimize a matching between position of at least some of the first marine objects determined using D_{camera} and the first position data, and second position data of at least some of the second marine objects, according to a criterion;
ix. using the first position data and the second position data comprises determining data D_{field_of_view} informative of a field of view of the imaging device which optimize a matching between position of at least some of the first marine objects determined using D_{field_of_view} and the first position data, and second position data of at least some of the second marine objects, according to a criterion;
x. obtaining a set of first position data informative of a position of first marine objects, wherein the set of first position data is obtained based on images acquired by the at least one imaging device of the marine vessel, wherein the set of first position data comprises, for each object of a plurality of the first marine objects, a position of the object at a plurality of first periods of time,
xi. the method comprises obtaining a set of second position data informative of a position of second marine objects, wherein the set of second position data comprises, for each object of a plurality of the second marine objects, a position of the object at a plurality of periods of time, wherein the first periods of time and the second periods of time meet a synchronization criterion, wherein the set of second position data is obtained based on data acquired by at least one sensor of the marine vessel, wherein the at least one sensor is different from the imaging device, wherein at least some of the first marine objects are the same as at least some of the second marine objects, and using the first set of position data and the second set of position data to estimate data informative of at least one of a height or an orientation of the imaging device over time;
xii. the method comprises tracking position of at least some of the first marine objects at the first periods of time and position of at least some of the second marine objects at the second periods of time, and using said tracking to estimate data D_{camera} informative of at least one of a height or an orientation of the imaging device which optimize a matching between a position of at least some of the first marine objects determined using D_{camera} and the set of first position data, and a position of the second marine objects obtained based on the second set of position data;
xiii. the method comprises obtaining first position data informative of a position of first marine objects, wherein the first position data is obtained based on images acquired by at least one imaging device of a marine vessel, obtaining second position data informative of a position of second marine objects, wherein the second position data is obtained based on data acquired by at least one first sensor of the marine vessel, wherein the at least one first sensor is different from the imaging device, obtaining third position data informative of a position of third marine objects, wherein the third position data is obtained based on data acquired by at least one second sensor of the marine vessel, wherein the at least one second sensor is different from the imaging device and from the first sensor, wherein at least some of the first, second and third marine objects are the same marine objects, using the first position data, the second position data and the third position data to estimate data informative of at least one of a height or an orientation of the imaging device of the marine vessel;
xiv. the method comprises associating at least some of the second marine objects with at least some of the third marine objects to generate an aggregated set of marine objects, each associated with a position provided by the first sensor or the second sensor;
xv. the method comprises determining data D_{camera} informative of at least one of a height or an orientation of the imaging device which optimize a matching between position of at least some of the first marine objects projected in a common referential using D_{camera} and the first position data, and position in the common referential of at least some of the second marine objects according to a criterion;
xvi. the method comprises iteratively estimating data informative of at least one of a height or an orientation of the imaging device for a given period of time, until a convergence criterion is met;
xvii. the method comprises determining that a marine object of the first marine objects and a marine object of the second marine objects correspond to a same given marine object acquired respectively by the imaging device and the at least one sensor, and determining a parameter of the given marine object using data provided by the at least one sensor or determining a parameter of the given marine object using data provided by the imaging device;
xviii. the method comprises determining a position of at least one given object of the first marine objects acquired by the imaging device based on second position data of a given object of the second marine objects, wherein a matching between the given object of the first marine objects and the given object of the second marine objects has been determined based on at least part of the first position data and the second position data;
xix. the first data comprises data informative of a type of the first marine objects and the second data comprises data informative of a type of the second marine objects;
xx. the method comprises estimating data informative of at least one of a height or an orientation of the imaging device comprises using data informative of a type of the first marine objects and data informative of a type of the second marine objects to determine a matching between at least some of the first marine objects and at least some of the second marine objects;
xxi. the method comprises using data informative of at least one of a height or an orientation of the imaging device as estimated and an image of a marine object acquired by the imaging device to determine data informative of a position of the marine object in a referential independent of the image, or data informative of a distance between the marine object and the marine vessel;
xxii. the marine object is acquired by the imaging device of the marine vessel, but is not detected by any of the other sensors present in the marine vessel, wherein said other sensors are not imaging devices;
xxiii. the method comprises comprising using data informative of at least one of a height or an orientation of the imaging device as estimated to output a position of a marine object as acquired by the imaging device and a position of another marine object acquired by the other sensor in a common referential;
xxiv. the method comprises using data informative of at least one of a height or an orientation of the imaging device as estimated, and images of the marine object acquired by the imaging vessel, to determine a velocity of the marine object relative to the marine vessel;
xxv. the method comprises using data informative of at least one of a height or an orientation of the imaging device as estimated to calibrate another sensor of the marine vessel, different from the imaging device;
xxvi. the method comprises, by the PMC, for each of a plurality of first given marine objects of the first marine objects and second given marine objects of the second marine objects determining that the first given marine object and the second given marine object correspond to a same given marine object of a plurality of given marine objects acquired by the imaging device and the at least one sensor and generating a dataset of a plurality of labelled images, wherein each labelled image comprises an image of a given marine object of said plurality of given marine objects, and a label;
xxvii. the label is determined by the PMC based on data provided by at least one of the imaging device and the at least one sensor;
xxviii. the method comprises, by the PMC, for each of a plurality of first given marine objects of the first marine objects and second given marine objects of the second marine objects: determining that the first given marine object and the second given marine object correspond to a same given marine object of a plurality of given marine objects acquired by the imaging device and the at least one sensor, and generating a database comprising for each of said plurality of given marine objects, data informative of said plurality of given marine objects, and data informative of performance of detection of said plurality of given marine objects by at least one of the imaging device and the at least one sensor.

In accordance with certain aspects of the presently disclosed subject matter, there is provided a non-transitory storage device readable by a machine, tangibly embodying a program of instructions executable by the machine to perform operations as described with reference to the method above.

In accordance with certain aspects of the presently disclosed subject matter, there is provided a system comprising a processor and memory circuitry (PMC) configured to estimate data informative of at least one of a height or an orientation of at least one imaging device of a marine vessel, wherein at least one of the height and the orientation of the at least one imaging device is variable over time, the estimating comprising obtain first position data informative of a position of first marine objects, wherein the first position data is obtained based on images acquired by at least one imaging device of a marine vessel, obtain second position data informative of a position of second marine objects, wherein the second position data is obtained based on data acquired by at least one sensor of the marine vessel, wherein the at least one sensor is different from the imaging device, wherein at least some of the first marine objects are the same as at least some of the second marine objects, and use the first position data and the second position data to estimate data informative of at least one of a height or an orientation of the imaging device of the marine vessel.

In addition to the above features, the system according to this aspect of the presently disclosed subject matter can optionally comprise (or be configured to implement) one or more of features (i) to (xxviii) as described above.

In accordance with certain aspects of the presently disclosed subject matter, there is provided a marine vessel comprising at least one imaging device, at least one sensor different from the image device, a processor and memory circuitry (PMC) configured to estimate data informative of at least one of a height or an orientation of the at least one imaging device, wherein at least one of the height and the orientation of the at least one imaging device is variable over time, the estimating comprising: obtain first position data informative of a position of first marine objects, wherein the first position data is obtained based on images acquired by at least one imaging device of a marine vessel, obtain second position data informative of a position of second marine objects, wherein the second position data is obtained based on data acquired by at least one sensor of the marine vessel, wherein the at least one sensor is different from the imaging device, wherein at least some of the first marine objects are the same as at least some of the second marine objects, and use the first position data and the second position data to estimate data informative of at least one of a height or an orientation of the imaging device of the marine vessel.

In addition to the above features, the marine vessel according to this aspect of the presently disclosed subject matter can optionally comprise (or be configured to implement) one or more of features (i) to (xxxviii) as described above.

In accordance with certain aspects of the presently disclosed subject matter, there is provided a system comprising a processor and memory circuitry (PMC) configured to obtain first position data informative of a position of first marine objects, wherein the first position data is obtained based on images acquired by at least one imaging device of a marine vessel, obtain second position data informative of a position of second marine objects, wherein the second position data is obtained based on data acquired by at least one sensor of the marine vessel, wherein the at least one sensor is different from the imaging device, wherein at least some of the first marine objects are the same as at least some of the second marine objects, determine a match between at least some of the first marine objects and at least some of the second marine objects using the first position data and the second position data, and generate a database informative of at least some of the first marine objects and the second marine objects using said match and data informative of the first marine objects and the second marine objects determined based on data provided by at least one of the imaging device and the at least one sensor.

According to some embodiments, the proposed solution proposes an innovative approach in which an imaging device acquires data informative of the environment of a marine vessel, in order to improve knowledge of the environment of the marine vessel and/or knowledge of the position of the marine vessel.

According to some embodiments, the proposed solution relies on a multi-sensor approach, in which a smart combination of information provided by the various sensors enables to determine data informative of marine targets in a more complete and accurate way, and in real time.

According to some embodiments, the proposed solution enables automatically determining height and/or orientation of an imaging device of a marine vessel.

According to some embodiments, the proposed solution enables to be independent from manual procedures.

According to some embodiments, although height and/or orientation of a marine vessel can vary drastically during the voyage of the marine vessel (e.g., due to changes in the weight of the freight, variations in the weather conditions, maneuvers of the marine vessel, or other factors), the proposed solution enables to repetitively (and automatically) update an estimation of a height and/or orientation of an imaging device of a marine vessel.

According to some embodiments, the proposed solution takes advantage of the fact that some sensors better perform than other in some situations, whereas in other situations this can be the opposite. In light of the foregoing, the proposed solution proposes to perform a smart aggregation between the data provided by the various sensors depending on the situation, thereby providing an efficient solution. The proposed solution therefore compensates drawbacks of each sensor.

According to some embodiments, the proposed solution solves technical challenges which are specific to imaging devices mounted on a marine vessel.

According to some embodiments, the proposed solution proposes to use an imaging device in addition to non-imaging sensors already present in the marine vessel, to provide a robust and complete solution for assisting marine navigation and control. As a consequence, it can be implemented in existing marine vessels in a flexible manner.

According to some embodiments, the proposed solution enables a marine vessel to determine its own parameters and/or parameters of the targets surrounding the marine vessel.

According to some embodiments, the proposed solution enables to determine marine vessel position without requiring localization systems such as GPS which are vulnerable to spoofing.

According to some embodiments, the proposed solution enables mapping the marine objects surrounding a marine vessel.

According to some embodiments, the proposed solution enables determining position of marine objects which do not have a localization system.

According to some embodiments, the proposed solution enables converting various data of marine objects from a relative referential of an image to an absolute referential.

According to some embodiments, the proposed solution enables calibrating/recalibrating one or more sensors present on a marine vessel.

According to some embodiments, the proposed solution improves control of trajectory of marine vessels.

According to some embodiments, the proposed solution reduces the risk of collision of a marine vessel with other marine objects. Safety and reliability of marine vessels are thus improved.

According to some embodiments, the proposed solution enables generating automatically a dataset of labelled images of marine objects, usable for training a neural network.

According to some embodiments, the proposed solution enables generating a comprehensive database informative of marine objects.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an embodiment of a system which can be used to perform one or more of the methods described hereinafter;

FIG. 2A illustrates an embodiment of a method of determining data informative of a height and/or orientation of an imaging device of a marine vessel (as explained hereinafter, additional state parameters of the marine vessel can be determined);

FIG. 2B illustrates a variant of the method of FIG. 2A;

FIG. 2C illustrates an example of tracking marine objects over a plurality of images acquired by an imaging device of a marine vessel;

FIG. 2D illustrates a method of determining data informative of a height and/or orientation of an imaging device of a marine vessel over time;

FIG. 2E illustrates operations which can be performed in accordance with the method of FIG. 2A;

FIG. 2F illustrates schematically a projection of the position of the marine objects acquired by the imaging device and the position of the marine objects acquired by another sensor into a common referential;

FIG. 2G illustrates an embodiment of a method of projecting position of a marine object from the image to a global/absolute referential (independent from the image);

FIGS. 2H to 2K illustrate parameters that can be used in the method of FIG. 2G;

FIG. 2L illustrates an example of an output of the method of FIG. 2E;

FIG. 2M illustrates operations which can be performed in accordance with the method of FIG. 2B;

FIGS. 2N and 20 illustrate an embodiment of using tracking data of marine objects to improve solving of an optimization problem in the method of FIG. 2M;

FIGS. 3A and 3B illustrate an embodiment of using types of marine objects to improve solving of an optimization problem in the methods of FIGS. 2E and 2M;

FIG. 4A illustrates an embodiment of the method of FIG. 2A;

FIG. 4B illustrates another embodiment of the method of FIG. 2A;

FIG. 5A illustrates an embodiment of a method of fusing parameters of multiple sensors;

FIG. 5B illustrates an embodiment of generating a database of marine objects;

FIG. 5C illustrates an embodiment of a method of determining absolute position of a marine object based on an estimation of height and/or orientation of an imaging device of the marine vessel;

FIGS. 6A and 6B illustrate an embodiment of a method of determining velocity of a marine object based on an estimation of height and/or orientation of an imaging device of the marine vessel;

FIG. 7 illustrates an embodiment of a method of determining position of marine objects surrounding a marine vessel in a common referential; and

FIG. 8 illustrates an embodiment of a method of calibrating another sensor of the marine vessel; and

FIG. 9 illustrates an embodiment of a method of determining absolute position of an imaging device of the marine vessel.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification discussions utilizing terms such as “obtaining”, “using”, “solving”, “determining”, “estimating”, “tracking”, “merging” or the like, refer to the action(s) and/or process(es) of a processor and memory circuitry (PMC) that manipulate and/or transform data into other data, said data represented as physical, such as electronic, quantities and/or said data representing the physical objects.

The term “processor and memory circuitry” (PMC) as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), and an application specific integrated circuit (ASIC), etc.) capable of executing various data processing operations.

It can encompass a single processor or multiple processors, which may be located in the same geographical zone, or may, at least partially, be located in different zones and may be able to communicate together.

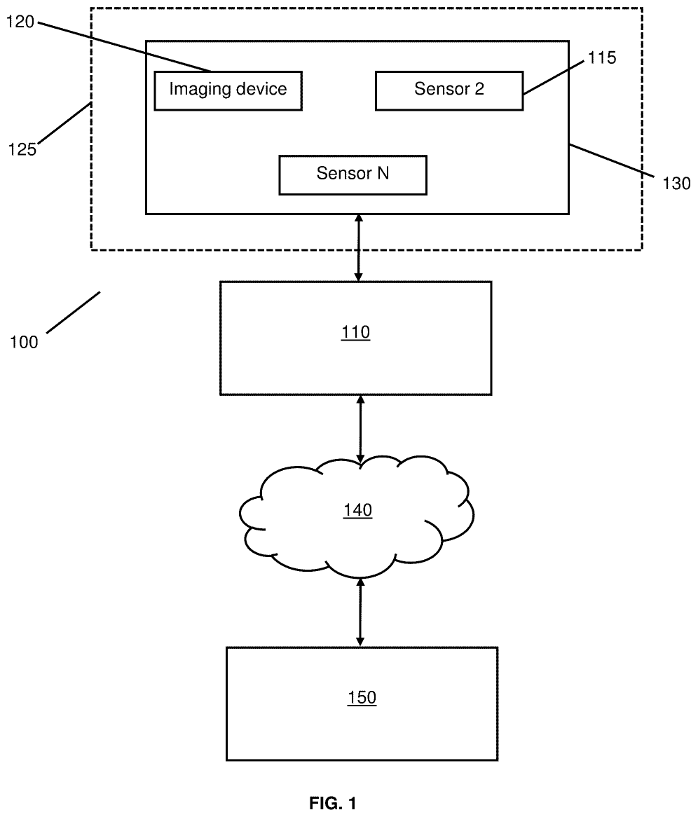

FIG. 1 illustrates an embodiment of a system 100 which can be used to perform one or more of the methods described hereinafter. As shown, system 100 comprises a processor and memory circuitry (PMC) 110.

System 100 can be embedded on a marine platform. In particular, the marine platform can be a moving marine platform. The moving marine platform can be e.g. a marine vessel 125. Marine vessels include e.g. ships, boats, hovercraft, etc.

In some embodiments, system 100 can be embedded on a marine platform which can be stationary, or at least temporarily stationary.

Although embodiments will be described with reference to marine vessels 125, it is to be understood that these embodiments apply similarly to a stationary marine platform.

As shown in FIG. 1, system 100 can obtain data from at least some of the sensors 130. At least some of the sensors 130 can be located on the marine vessel 125 on which system 100 is located (or on at least one other marine vessel/object communicating with the marine vessel 125 on which system 100 is located).

Sensors 130 collect data during the voyage of the marine vessel 125. The voyage includes portions of the voyage in which the marine vessel is in motion but can also include portions of the voyage in which the marine vessel is substantially static (e.g., when the marine vessel 125 is moored or docked such as at a harbor).

Sensors 130 can include an imaging device 120 (e.g. a camera).

In some embodiments, the camera includes an infrared camera, a night camera, a day camera, etc.

In some embodiments, sensors 130 include a plurality of imaging devices 120 (which can be distinct).

In addition, sensors 130 include one or more additional sensors 115 (which are not necessarily imaging devices) such as (this list is not limitative) a radar (any type of radar), a LIDAR, automatic identification system (AIS), a transponder communicating with GPS located on other marine objects, a system which includes a laser located on the marine vessel 125 and an optical reflector located on another marine object to be located by the marine vessel 125 (reflection of the laser by the reflector enables localization of the other marine object), etc.

In particular, sensors 115 provide information usable to localize marine objects surrounding the marine vessel 125.

The marine vessel 125 itself can include other sensors, such a geo-localization system (e.g. GPS), IMU, velocity and acceleration sensors, gyro compass, etc.

As explained hereinafter in the specification, system 100 can process data collected by sensors 130.

In some embodiments, data output by system 100 can be transmitted through a remote communication network 140 towards e.g., a central station 150, which can include at least one processor and memory circuitry (PMC).

In some embodiments, the central station 150 can perform at least some of the tasks of PMC 110 located on the marine vessel 125.

The remote communication link can correspond e.g. to a broadband cellular network (e.g. 4G, 5G, LTE, etc.), a satellite communication network, Radio communication network (such as Radio VHF—very high frequency), etc.

Data can be transmitted using a communication system located on the marine vessel 125 which is suitable to transmit data via the remote communication network. The communication system can include e.g., an antenna, an emitter, a transponder, etc.

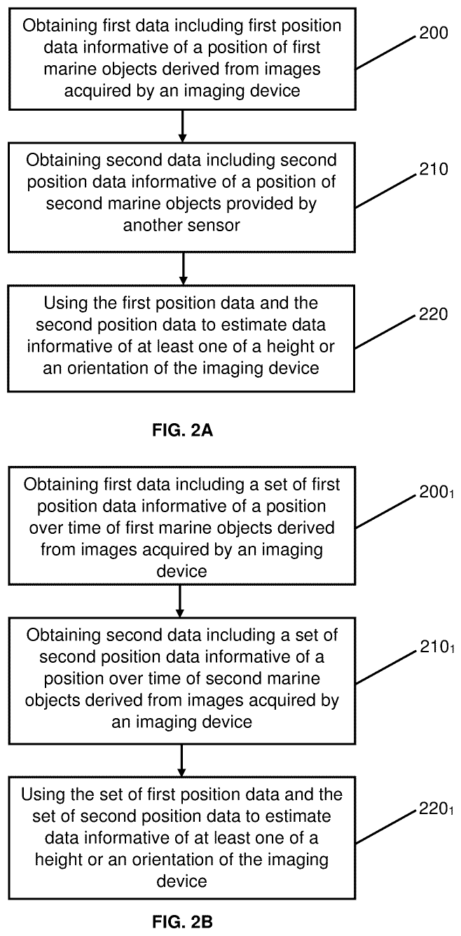

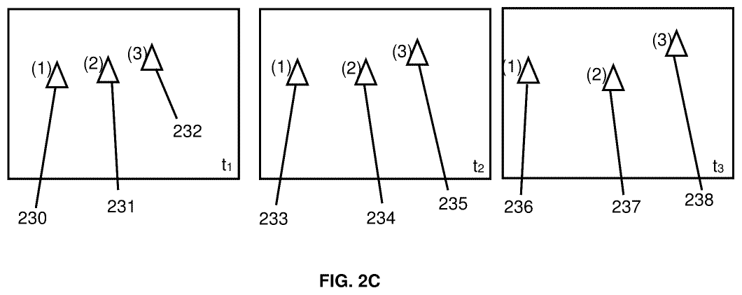

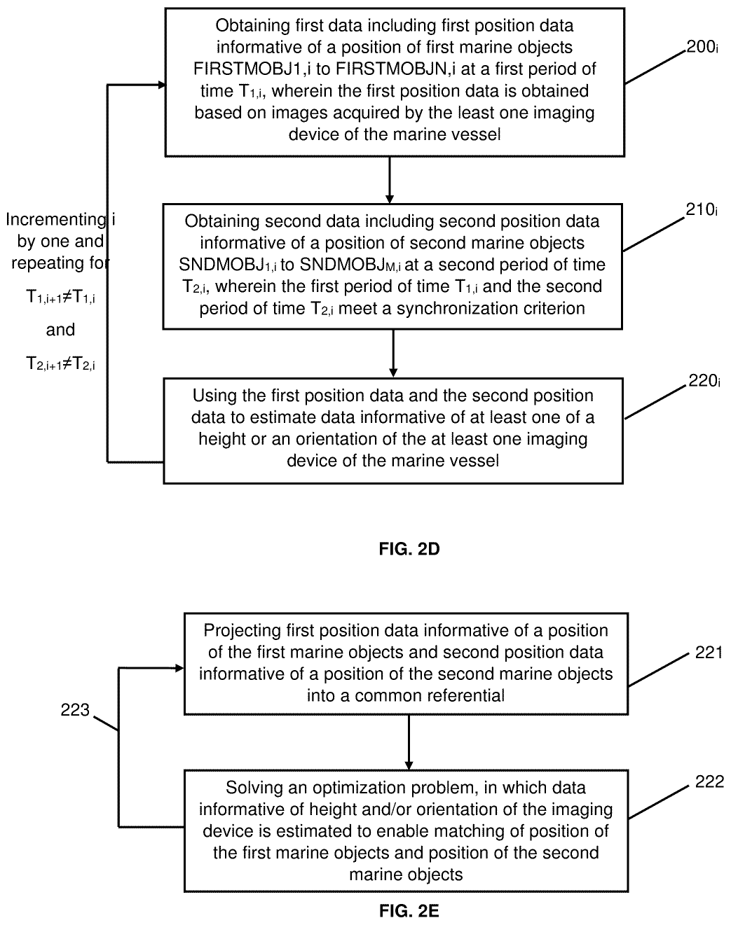

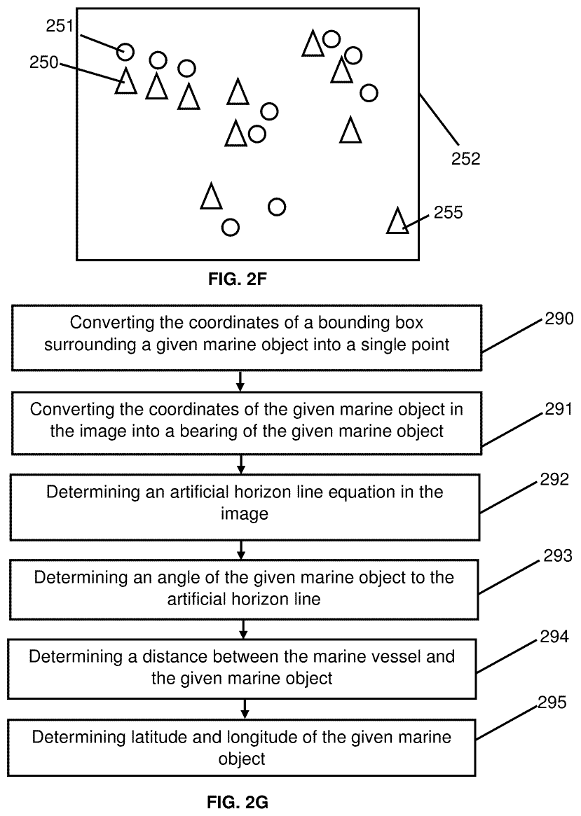

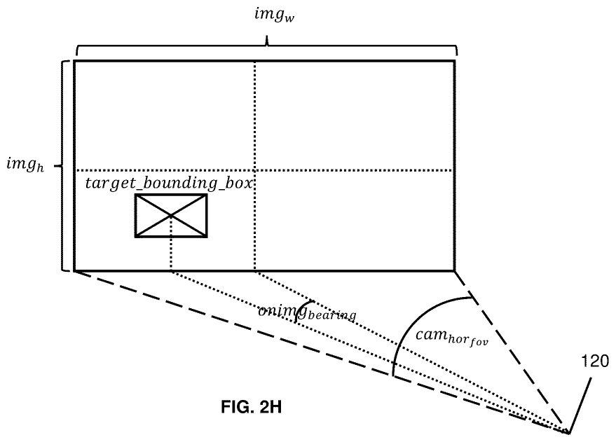

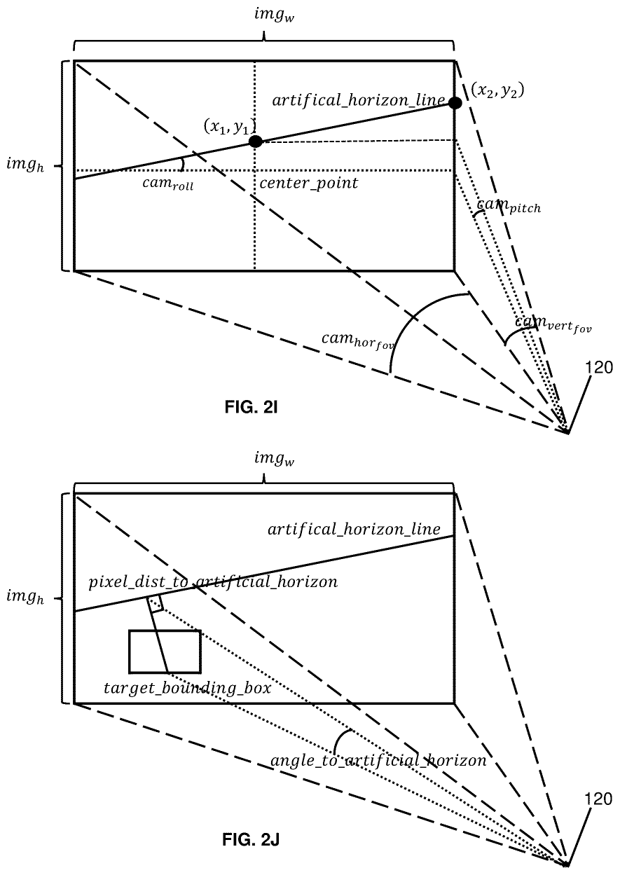

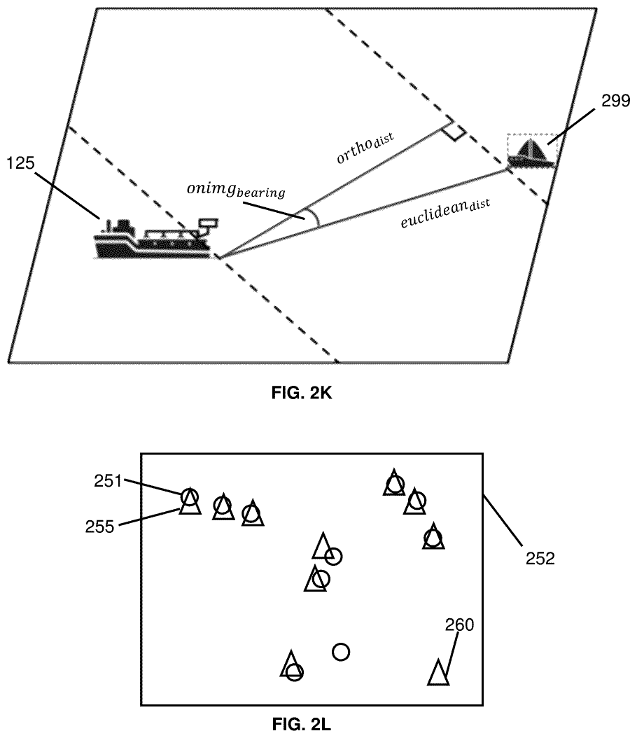

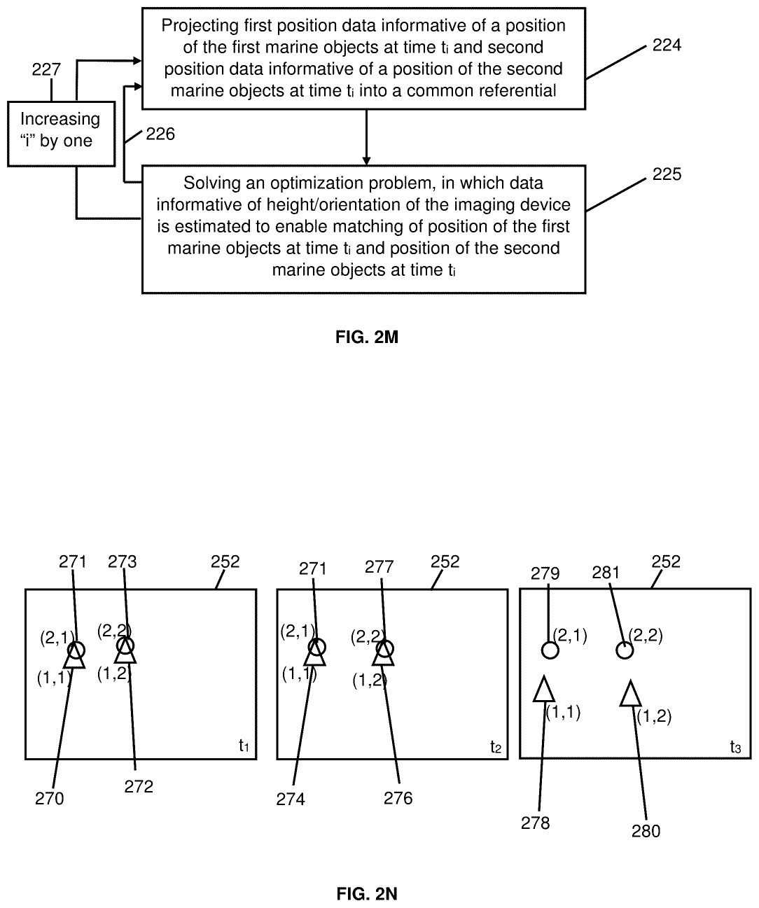

Attention is now drawn to FIG. 2A.

During the voyage of the marine vessel 125, data is acquired by one or more of the sensors 130 of the marine vessel 125.

Data are representative of one or more situations encountered by the marine vessel during its voyage.

In particular, during the voyage of the marine vessel 125, various objects (hereinafter marine objects—e.g. icebergs, buoys, other marine vessels, etc.) can be encountered by the marine vessel 125, and data informative of these marine objects can be acquired. The marine objects generally include at least a part which is located above sea level.

As shown in FIG. 2A, the method includes obtaining (operation 200) first data informative of first marine objects.

The first data is obtained based on images acquired by the imaging device 120 of the marine vessel 125. In some embodiments, the first data is obtained based on images acquired by a plurality of imaging devices 120 of the marine vessel 125. The first data includes first position data informative of a position of first marine objects.

Generally, the first position data is expressed in the referential of the imaging device 120. A PMC is configured to detect, in a given image acquired by the imaging device 120, marine objects present in the image. This detection can rely e.g. on an image processing algorithm. In some embodiments, a machine learning module (which implements e.g. a deep neural network) is trained to detect marine objects present in images acquired by an imaging device of a marine vessel. This training can include supervised learning in which a plurality of annotated images comprising marine objects are fed to the machine learning module. This is not limitative, and the training can also include automatic training and/or non-supervised learning.

In some embodiments, the machine learning module can provide information on the type of the object (e.g. marine vessel, type of marine vessel, iceberg, etc.). This can be obtained by performing supervised learning of the machine learning module, in which labelled images comprising marine objects (together with their type, which corresponds to the label) are fed to the machine learning module for its training.

Once a given marine object is detected in an image acquired by the imaging device 120, its position (e.g. pixel position comprising a position along the X axis of the image and a position along the Y axis of the image) in the image can be obtained. Therefore, for each marine object acquired by the imaging device 120, a position in the image can be obtained. The first position data can include, in some embodiments, the position of each given object of the first marine objects in the image in which the given object has been detected.

According to some embodiments, the imaging device 120 acquires a plurality of images at a plurality of periods of time. As a consequence, it is possible to obtain position over time of the first marine objects.

In particular, the method can include obtaining a set of first position data (see operation 2001 in FIG. 2B). The set of first position data includes, for each object of the first marine objects, position of the object at the plurality of periods of time.

Indeed, since the marine vessel 125 moves over time and/or at least some of the first marine objects move over time, the position of the first marine objects in the images acquired by the imaging device 120 can change over time.

According to some embodiments, in order to generate the set of first position data, it is possible to track the first marine objects in the plurality of images acquired by the imaging device 120.

A non-limitative example is provided with reference to FIG. 2C.

Assume that at time t₁, an image is acquired by the imaging device 120. In this image, three marine objects are detected. A first marine object is located at position 230, a second marine object is located at position 231, and a third marine object is located at position 232.

At time t₂ (different from t₁), another image is acquired by the imaging device 120. In this image, three marine objects are detected. A first marine object is located at position 233, a second marine object is located at position 234, and a third marine object is located at position 235.

At time t₃ (different from t₂), another image is acquired by the imaging device 120. In this image, three marine objects are detected. A first marine object is located at position 236, a second marine object is located at position 237, and a third marine object is located at position 238.

A tracking method can be used to track the various marine objects over the different images. The tracking method can be implemented by a PMC. The tracking method can implement e.g., a Kalman filter, or other adapted tracking methods.

In some embodiments, it can appear that a marine object is present in some of the images and disappear in subsequent images. This can be due to the relative motion between the marine object and the marine vessel 125.

In the example of FIG. 2C, the tracking method reveals that the marine object located at position 230 at time t₁, the marine object located at position 233 at time t₂ and the marine object located at position 236 at time t₃ correspond to the same object at different periods of time. Therefore, the same tracking ID (in this example “(1)”) can be assigned to indicate that the same marine object is present at different positions in the different images.

Similarly, the tracking method reveals that the marine object located at position 231 at time t₁, the marine object located at position 234 at time t₂ and the marine object located at position 237 at time t₃ correspond to the same marine object at different periods of time. Therefore, the same tracking ID (in this example “(2)”) can be assigned.

Similarly, the tracking method reveals that the marine object located at position 232 at time t₁, the marine object located at position 235 at time t₂ and the marine object located at position 238 at time t₃ correspond to the same marine object. Therefore, the same tracking ID (in this example “(3)”) can be assigned.

The method includes obtaining (210) second data informative of second marine objects.

Although FIG. 2A depicts a sequence in which the first position data is first obtained and then the second position data, this is not mandatory and this can be performed in the opposite way, or simultaneously. This is also true for the sequence depicted in FIG. 2B.

The second data is obtained based on data acquired by at least one sensor 115 of the marine vessel 125. Sensor 115 is different from imaging device 120. In some embodiments, sensor 115 is not an imaging device (e.g., not a camera). Various examples have been provided above for sensor 115 (e.g., a radar, AIS, etc.).

The second data includes second position data informative of a position of second marine objects encountered by the marine vessel 125 during its voyage. As explained hereinafter, according to some embodiments, the method projects position of the targets detected by the various sensors (which can be expressed in different referentials) within a common referential.

In some embodiments, a plurality of sensors 115 is available, which includes sensors 115 of different types (e.g., a first sensor is a radar, a second sensor is AIS, a third sensor is GPS, etc.). In this case, for each sensor, position data of marine objects detected by this sensor is obtained. As explained hereinafter, each sensor can detect different marine objects, but at least a plurality of the marine objects surrounding the marine vessel 125 is detected by different sensors 115.

At least some of the first marine objects and the second marine objects correspond to the same physical marine objects. For example, the first marine objects include a first given marine vessel, a second given marine vessel, and a buoy. The second marine objects include the first given marine vessel, the second given marine vessel, and an iceberg.

This difference between the first marine objects and the second marine objects can be due to the fact that the imaging device 120 and the other sensors 115 have a different field of view, and/or a different line of sight, and/or different capabilities of detecting objects (e.g., depending on the type of the sensor, its capability to detect objects can depend e.g. on weather conditions, size of the object, type of the object, etc.). In addition, the imaging device 120 and the other sensor(s) 115 can present other differences (for example, the imaging device 120 can be used to classify marine objects, which is not possible for all sensors 115, such as radar).

Distance between the marine vessel 125 and the marine objects can also impact the detection of the marine objects by the sensors of the marine vessel 125. For example, a radar is operative to detect marine objects at medium-long range, but has a blind zone at short range, whereas the imaging device 120 better performs at short range than at long range for detecting marine objects. Therefore, not all marine objects are detected by all sensors of the marine vessel 125.

In some embodiments, the first marine objects and the second marine objects are the same. This means that all sensors 130 have been able to detect the same marine objects.

The second position data is expressed in a referential which can depend on the sensor 115.

For example, if sensor 115 is an AIS, absolute position (latitude, longitude in world coordinates) of the marine objects is obtained.

If sensor 115 is a radar, position of the marine object relative to the marine vessel 125 is obtained (expressed e.g., as a range and an angular position relative to the radar and/or marine vessel 125).

According to some embodiments, the second data can include additional data (in addition to the second position data of the second marine objects).

According to some embodiments, the second data includes identification data of the second marine objects. For example, the AIS provides identification data specific to each object, which enables its identification.

According to some embodiments, the second data includes data informative of the type (e.g. type of marine vessel, etc.) of the marine object (which can be provided by sensor(s) 115 and/or which can be derived from data provided by sensor(s) 115).

For example, the AIS can provide type of the marine object.

According to some embodiments, sensor 115 acquires data at a plurality of periods of time (e.g., while the marine vessel 125 is in motion). As a consequence, it is possible to obtain position over time of the second marine objects. As explained hereinafter, tracking data of the marine objects can be used to improve matching/association between the first and second marine objects. This is however not mandatory.

In particular, the method can include obtaining a set of second position data (operation 2101 in FIG. 2B). The set of second position data includes, for each given object of the second marine objects, position of the given object at the plurality of periods of time.

In order to track the second marine objects over the different acquisitions, several methods can be used.

In some embodiments, if sensor 115 provides identification data specific to each object, it is possible to track the object over the plurality of periods of time, thereby enabling generating the set of second position data. For example, if sensor 115 is an AIS, it is possible to track the position of the objects over time since each object is associated with specific identification data provided by the AIS.

If sensor 115 is a radar, the objects can be tracked over the various radar acquisitions (that is to say, at the plurality of periods of time), using regular radar tracking.

According to some embodiments, the first position data informative of a position of first marine objects (respectively, the set of first position data) corresponds to a position at a first period of time (respectively at a plurality of first periods of time), and the second data informative of a position of second marine objects (respectively the set of first position data) corresponds to a position at a second period of time (respectively at a plurality of second periods of time).

The first period of time (respectively first periods of time) and the second period of time (respectively second periods of time) meet a synchronization criterion. The synchronization criterion ensures that the time difference between the respective first period(s) of time and the respective second period(s) of time is below a threshold. For example, the synchronization criterion can ensure that a time difference between the respective first period(s) of time and the respective second period(s) of time is below 1 sec. This value is however not limitative. In particular, if the respective first period(s) of time and the respective second period(s) of time do not meet the synchronization criterion, it possible to perform up-sampling of the data provided by the sensors (using e.g. a Kalman filter—this is not limitative). Similarly, if necessary, down-sampling can be performed.

As a consequence, the first period(s) of time and the second period(s) of time are substantially identical.

The method further includes (operation 220) using the first position data and the second position data to estimate data informative of at least one of a height or an orientation of the imaging device 120. In some embodiments, both data informative of a height and an orientation of the imaging device is estimated, or only part of this data (e.g. because at least some of this data is already known, using e.g. other sensors and/or external input). Generally, at least one of the height and the orientation of the at least one imaging device is variable overtime, since orientation and/or position of the marine vessel evolves over time.

Data informative of an orientation of the imaging device 120 includes at least one of a roll of the imaging device 120, a pitch of the imaging device 120, a yaw of the imaging device 120, etc. This orientation can be expressed similarly as roll/pitch/yaw of a ship (for example, the roll axis is an imaginary line running horizontally through the length of the ship, through its centre of mass, and parallel to the waterline, the pitch axis is an imaginary line running horizontally across the ship and through its centre of mass, and the yaw axis is an imaginary line running vertically through the ship and through its centre of mass).

Data informative of a height (also called altitude or elevation) of the imaging device 120 can be also estimated. Height of the imaging device 120 can be expressed for example relative to sea level (also called mean sea level—MSL, or relative to still-water level—SWL).

As explained hereinafter, once one or more parameters of the imaging device 120 have been determined, additional position data (e.g. absolute position of the imaging device) can be determined.

As mentioned above, in some embodiments, position data of the marine objects at a plurality of periods of time is obtained.

According to some embodiments, the method can include using (operation 220₁ in FIG. 2B) the set of first position data (which includes position of the first marine objects at a plurality of periods of time derived from images acquired by the imaging device 120) and the set of second position data (which includes position of the second marine objects at a plurality of periods of time derived from data acquired by sensor 115) to estimate data informative of at least one of a height or an orientation of the imaging device 120 over time.

As explained hereinafter, estimating data informative of height and/or orientation of the imaging device 120 can include attempting to match position of the first marine objects and position of the second marine objects (in order to reflect the fact that they correspond to the same marine objects acquired by different sensors), by modifying value of the height and/or orientation of the imaging device 120 (which is to be estimated).

According to some embodiments, a filter (e.g. probabilistic filter) can be used which predicts the expected variations in orientation and/or height of the imaging device 120 (depending e.g. on the weather conditions). This is useful to filter out estimation of the height and/or orientation of the imaging device 120 which is not realistic and corresponds to noise.

FIG. 2D illustrates a method in which data informative of at least one of a height or an orientation of the imaging device 120 of the marine vessel 125 is estimated over time. As shown in FIG. 2D, the method is iterative over time.

The method includes obtaining (operation 200₁) first position data informative of a position of first marine objects FIRSTMOBJ_{1,i} to FIRSTMOBJ_{N,i} at a first period of time T_{1,i}, wherein the first position data is obtained based on images acquired by the imaging device 120 of the marine vessel 125. Operation 200 is similar to operation 200.

The method includes obtaining (operation 210ᵢ) second position data informative of a position of second marine objects SNDMOBJ_{1,i} to SNDMOBJ_{M,i} at a second period of time T_{2,i}, wherein the first period of time T_{1,i} and the second period of time T_{2,i} meet a synchronization criterion (see above a possible definition of this criterion). The second position data is obtained based on data acquired by the at least one sensor 115 of the marine vessel 125. Operation 210i is similar to operation 210.

At least some of the first marine objects FIRSTMOBJ_{1,i} to FIRSTMOBJ_{N,i} are the same as at least some of the second marine objects SNDMOBJ_{1,i} to SNDMOBJ_{M,i}.

The method includes (operation 220ᵢ) using the first position data and the second position data to estimate data informative of at least one of a height or an orientation of the imaging device 120 of the marine vessel 125. Operation 220ᵢ is similar to operation 220. As a consequence, data informative of at least one of a height or an orientation of the imaging device 120 is estimated at a given period of time T′ᵢ, which substantially coincides with the first period of time T_{1,i} and the second period of time T_{2,i} (as mentioned the first period of time T_{1,i} and the second period of time substantially T_{2,i} coincide since they meet a synchronization criterion). In other words, T′ᵢ≈T_{1,i}≈T_{2,i}.

As shown in FIG. 2D, operation 200ᵢ is repeated at a different first period of time T_{1,i+1} (which occurs after T_{1,i}−i has been incremented by one in the flow chart of FIG. 2D). Therefore, at time T_{1,i+1}, first position data informative of a position of first marine objects FIRSTMOBJ_{1,i+1} to FIRSTMOBJ_{N,i+1} is obtained. It has to be noted that the first marine objects FIRSTMOBJ_{1,i+1} to FIRSTMOBJ_{N,i+1} of time Tᵢ₊₁ can differ from the first marine objects FIRSTMOBJ_{1,i} to FIRSTMOBJ_{N,i} of time Tᵢ. This is however not mandatory, and depends on the scenario (in some cases, there is a partial overlap).

Operation 210ᵢ is repeated at a different second period of time T_{2,i+1} (which occurs after T_{2,i}). Therefore, at time T_{2,i+1}, second position data informative of a position of second marine objects SNDMOBJ_{1,i+1} to SNDMOBJ_{M,i+1} is obtained. It has to be noted that the second marine objects SNDMOBJ_{1,i+1} to SNDMOBJ_{M,i+1} of time Tᵢ₊₁ can differ from the second marine objects SNDMOBJ_{1,i} to SNDMOBJ_{M,i} of time Tᵢ. This is however not mandatory, and depends on the scenario (in some cases, there is a partial overlap).

T_{1,i+1} and T_{1,i+1} meet a synchronization criterion.

At least some of the first marine objects FIRSTMOBJ_{1,i+1} to FIRSTMOBJ_{N,i+1} are the same as at least some of the second marine objects SNDMOBJ_{1,i+1} to SNDMOBJ_{M,i+1}.

Operation 220ᵢ is repeated in order to estimate data informative of at least one of a height or an orientation of the at least one imaging device of the marine vessel. As a consequence, data informative of at least one of a height or an orientation of the imaging device 120 is estimated at a given period of time T′ᵢ₊₁, which substantially coincides with the first period of time T_{1,i+1} and the second period of time T_{2,i+1} (as mentioned the first period of time T_{1,i+1} and the second period of time substantially T_{2,i+1} coincide since they meet a synchronization criterion). In other words, T′ᵢ₊₁≈T_{1,i+1}≈T_{2,i+1}.

The method therefore enables to estimate at least one of a height or an orientation of the imaging device 120 over time.

According to some embodiments, height and/or orientation of the imaging device 120 is estimated in real time or quasi real time (a small delay can be present due to the time for the sensors of the marine vessel to acquire the data and the time for processing this data).

Assume that data informative of at least one of a height or an orientation of the imaging device 120 is estimated at a given period of time (corresponding to a given iteration i of the method of FIG. 2D). In some embodiments, this data can be used to improve estimation of at least one of a height or an orientation of the imaging device 120 at a subsequent period of time (corresponding to a given iteration i+1 of the method of FIG. 2D). For example, the estimation obtained at iteration i can be used as a starting point of the algorithm which attempts to estimate the height and/or orientation at iteration i+1. In other words, results of a previous iteration can be used to improve estimation at a subsequent iteration.

In some embodiments, and as explained hereinafter, estimation of the height and/or orientation of the imaging device 120 includes determining an association or match between the first marine objects and the second marine objects at a given iteration. The association determined at a given iteration “i” of the method can be reused as an input of the method at a subsequent iteration “i+1” (or more generally at an iteration “j”, with j>i), to improve determination of the association at the subsequent iteration. For example, as explained hereinafter, if two given marine objects have been identified as matching at a previous iteration of the method of FIG. 2D, a term (reward) can be introduced in a loss function (calculated at a subsequent iteration of the method—see hereinafter embodiments which rely on a loss function) which takes into account this information.

FIG. 2E illustrates an embodiment of a method of which can be used to perform operation 220 or operation 220₁ or operation 220ᵢ.

As shown in FIG. 2E, the method includes projecting (221) first position data informative of a position of the first marine objects and second data informative of a position of the second marine objects into a common referential.

Although FIG. 2E depicts a sequence in which the first position data is first projected, and then the second position data, this is not limitative and this could be performed in the opposite way, or simultaneously.

The common referential can correspond e.g. to a global/absolute referential such as world coordinates (latitude, longitude). This is not limitative and other referentials can be used. For example, a predefined set of coordinates which share the same plane can be used (for example the set of coordinates is expressed relative to the marine vessel's position, which is selected as the origin of the set of coordinates).

As explained above, the first position data is generally expressed in the referential of the image (referential of the imaging device 120).

In order to convert the first position data into the common referential, an assumption on the data informative of the height and/or orientation of the imaging device 120 can be made.

Based on this assumption, and the known position of the first marine objects in the referential of the image(s) acquired by the imaging device 120, it is possible to project the first position data from the referential of the image into the common referential.

A method of projecting the first position data into the common referential is described hereinafter with reference to FIG. 2G.

In some embodiments, at least some of the position data is already expressed in the common referential.

For example, an AIS may provide position data in world coordinates.

If position data is provided by a radar, it is possible to convert the position data in world coordinates by using the position of the marine vessel 125. Indeed, since the radar provides relative position (range/bearing), and the position of the marine vessel 125 is known (using e.g. a localization system such as GPS/AIS of the marine vessel 125), it is possible to project the position data into world coordinates (or into another common referential).

FIG. 2F illustrates a projection of the first position data and the second position data into a common referential 252 (global/absolute referential, such as Earth referential).

Projection of the first position data into the common referential 252 depends inter alia on the height and orientation of the imaging device 120.

At this stage, since height and/or orientation of the imaging device 120 is unknown (or known with an error), the first position data is projected randomly, and therefore position of the first marine objects (depicted as triangles) does not match position of the second marine objects (depicted as circles).

FIG. 2G illustrates a method of projecting the first position data from the referential of the image into a common referential (global/absolute referential—independent of the referential of the image).

It has to be noted that this method is not limitative and is provided as an example only.

Assume that a given marine object 299 (depicted in FIG. 2K) has been identified in an image acquired by the imaging device 120.

For example, a bounding box (see FIG. 2H, “target_bounding_box”) including the given marine object 299 is obtained. Assume the following notations:
i. (leftᵤₚₚₑᵣ_{ₓ}, leftᵤₚₚₑᵣ_{_{y}}) correspond to the coordinates of the left upper point of the bounding box (in the image);
ii. (right_{bottom}_{ₓ}, right_{bottom}_{_{y}}) correspond to the coordinates of the right lower point of the bounding box (in the image);
iii. camᵥₑᵣₜ_{_{fov}}, camₕₒᵣ_{_{fov}} correspond respectively to the imaging device vertical field of view and to the imaging device horizontal field of view;
iv. img_{w} and imgₕ correspond to the image resolution (width by height);
v. camₗₐₜ, cam_{long} correspond respectively to the latitude and longitude of the imaging device 120;
vi. cam_{height} corresponds to the height of the imaging device 120, relative to sea level (it is assumed that the marine vessel 125 and the given marine object are located at the same water surface);
vii. cam_{pitch}, camᵣₒₗₗ and cam_{yaw} correspond respectively to the pitch of the imaging device 120, the roll of the imaging device 120 and the yaw of the imaging device 120 (it is generally assumed that the imaging device 120 and the marine vessel 125 form a rigid body); and
viii. targₗₐₜ and targₗₒₙ correspond respectively to the latitude of the given marine object and the longitude of the given marine object;

Parameters (i) to (vii) are the input of the method, and parameter (viii) is an output of the method.

The method includes converting (operation 290) the coordinates of the two extremities of the bounding box into a single point, with coordinates (targetₓ, target_{y}).

$${target}_{x} = \frac{{left}_{{upper}_{x}} - {right}_{{bottom}_{x}}}{2}$$

$${target}_{y} = \frac{{left}_{{upper}_{y}} - {right}_{{bottom}_{y}}}{2}$$

The method includes converting (291) the coordinates (targetₓ, target_{y}) of the given marine object into a bearing (noted global_bearing) of the given marine object expressed in an absolute referential (e.g. Earth referential), as detailed hereinafter.

$${left}_{{img}_{angle}} = - \frac{cam\_hor \_fov}{2}$$

$${right}_{{img}_{angle}} = \frac{cam\_hor \_fov}{2}$$

$${onimg}_{bearing} = \frac{( {target}_{x} ( {right}_{{img}_{angle}} - {left}_{{img}_{angle}} ) )}{{img}_{w}} + {left}_{{img}_{angle}}$$

$${global}_{bearing} = ( {onimg}_{bearing} + {cam}_{yaw} + 3 \; 60 ) mod ( 360 )$$

The method further includes (292) determining an artificial horizon line equation in the image (the artificial horizon line corresponds to a reference for which the imaging device 120 has zero roll and zero pitch). FIG. 2I illustrates a non-limitative example of an artificial horizon line and some of the parameters which are used to determine its equation.

A normalization function old_to_new_value(oldᵥₐₗᵤₑ, old_{range}, new_{range}) is defined, in which oldᵥₐₗᵤₑ is the value that needs to be normalized, old_{range} corresponds to the current range (oldₘᵢₙ, oldₘₐₓ), new_{range} corresponds to the expected value range (newₘᵢₙ, newₘₐₓ) and newᵥₐₗᵤₑ corresponds to the output of the function. The function old_to_new_value can be defined as follows:

$${new}_{value} = ( \frac{( ( {old}_{value} - {old}_{min} ) ( {new}_{max} - {new}_{min} ) )}{{old}_{max} - {old}_{min}} ) + {new}_{min}$$

Operation 292 can include setting cam_{pitch} as the output of old_to_new_value(cam_{pitch}, (−90,90), (0,180)).

Operation 292 can further include calculating the artificial horizon line location in the image in pixels.

This can include determining pixel_{pitch} as follows:

$${pixel}_{pitc h} = old\_to \_new \_value ( {cam}_{pitc h} , ( 90 - \frac{{cam}_{{vert}_{fov}}}{2} , 90 + \frac{{cam}_{{vert}_{fov}}}{2} ) , ( 0 , {img}_{h} ) ) .$$

This can further include updating pixel_{pitch} as follows:

$${pixel}_{pitch} = abs ( cos ( {cam}_{r o l l} ) ) {pixel}_{p i tch} .$$

This can further include defining (x₁, y₁) as follows:

$$( {x}_{1} , {y}_{1} ) = ( \frac{i m {g}_{w}}{2} , {pixel}_{p i t c h} )$$

(x₁, y₁) corresponds to a first point of the artificial horizon line (see FIG. 2I).

This can further include defining (x₂, y₂) as follows:

$$( {x}_{2} , {y}_{2} ) = ( \frac{i m {g}_{w}}{2} , 0 ) , if {cam}_{p i t c h} = 90 ;$$

$$( {x}_{2} , {y}_{2} ) = ( \frac{i m {g}_{w}}{2} , {y}_{1} ) , if {cam}_{p i t c h} = 0 or 180 ;$$

$$( {x}_{2} , {y}_{2} ) = ( \frac{i m {g}_{w}}{2} , \frac{( {y}_{1} + i m {g}_{w} tan ( c a {m}_{r o l l} ) )}{2} ) , for other values of {cam}_{p i t c h} .$$

(x₂, y₂) corresponds to a second point of the artificial horizon line (see FIG. 2I).

The equation of the artificial horizon line can be calculated using (x₁, y₁) and (x₂, y₂).

The method further includes (293) determining an angle (noted angle_to_artificial_horizon) of the given marine object with respect to the artificial horizon line (see FIG. 2J). Operation 293 can include determining a distance (see FIG. 2J, pixel_dist_to_artificial_horizon) in pixels in the image between the bounding box of the given marine object (see FIG. 2J, target_bounding_box) and the artificial horizon line (this can be performed by simple trigonometry calculation). Operation 293 can then include determining angle_to_artificial_horizon using the following computation:

$${angle}_{{per}_{p \dot{ι} xel}} = \frac{c a {m}_{ver {t}_{fov}}}{i m {g}_{h}}$$

$$angle\_to \_artificial \_horizon = pixel\_dist \_to \_artificial \_horizon * {angle}_{{per}_{p \dot{ι} x e l}}$$

The method further includes (294) determining a distance (Euclidean distance, noted euclidean_{dist}) between the marine vessel 125 and the given marine object 299, as detailed hereinafter. Operation 294 can include a preliminary step of determining an ortho distance (see FIG. 2K—noted hereinafter ortho_dist) between the marine vessel 125 and the given marine object 299.

$${ortho}_{dist} = tan ( 90 - angle\_to \_artificial \_horizon ) {cam}_{h e i g h t}$$

In some embodiments, ortho_{dist} can be corrected to take into account curvature of the Earth (see e.g. https://earthcurvature.com).

Operation 294 can then include performing the computation:

$${euclidean}_{dist} = \frac{{ortho}_{dist}}{cos ( abs ( {onimg}_{b e a r i n g} ) )}$$

The method further includes (295) determining absolute coordinates (latitude, longitude) of the given marine object 299. Operation 295 can include the following computation:

$$tar {g}_{l a t} = arcsin ( sin ( c a {m}_{l a t} ) cos ( \frac{d}{R} ) + cos ( c a {m}_{lat} ) sin ( \frac{d}{R} ) cos ( bearing ) )$$

$${targ}_{lon} = {targ}_{lat} + a tan 2 ( cos ( \frac{d}{R} ) - sin ( c a {m}_{l a t} ) sin ( tar {g}_{l a t} ) , sin ( b ) sin ( \frac{d}{R} ) cos ( c a {m}_{l a t} ) )$$

In this equation, d is equal to euclidean_{dist}, R is the Earth's radius and b is equal to global_{bearing}.

The method of FIG. 2E further includes (operation 222) solving an optimization problem. In particular, data D_{camera} informative of a height and/or an orientation of the imaging device 120 is estimated to enable matching of position of at least some of the first marine objects determined using D_{camera} and the first position data, and second position data of at least some of the second marine objects. If D_{camera} is changed, projection of the first marine objects from the referential of the image (first position data) into the common referential 252 is changed (as visible in the equations provided above with reference to FIGS. 2G to 2K—see parameters cam_{pitch}, camᵣₒₗₗ, cam_{yaw} and cam_{height}).

This matching can be according to a criterion (as explained hereinafter, the criterion can define e.g. a number of iterations of the method and/or a minimal value for a loss function).

As mentioned above, modification of an estimation of the height and/or orientation of the imaging device 120 (“D_{camera}”) induces that a projection of the position of the first marine objects from the referential of the image (first position data) into the common referential 252 is modified. Modification of D_{camera} does not affect the projection of the position of the second marine objects acquired by other sensors into the common referential 252.

Solving the optimization problem can include optimizing the estimation D_{camera} of the height and/or orientation of the imaging device 120 to optimize a matching between the position of the first marine objects (as recalculated using D_{camera} and the first position data) and the position of the second marine objects in the common referential. In particular, it is attempted to match between a position of a first marine object and a position of a second marine object which correspond to the same marine object.

In some embodiments, it is possible to estimate additional parameters of the imaging device 120, such as the field of view (data D_{field_of_view}, such as camᵥₑᵣₜ_{_{fov}}, and camₕₒᵣ_{_{fov}}) of the imaging device 120. Although the field of view of the imaging device is generally known, there can be a distortion which can be estimated.

In this case, solving the optimization problem can also include optimizing the values of the field of view to optimize a matching between the position of the first marine objects (as recalculated using D_{camera}, D_{field_of_view} and the first position data) and the position of the second marine objects in the common referential.

As visible in FIG. 2E, the method is generally iterative (see reference 223). In other words, solving the optimization problem can include various iterations (e.g. N iterations, with N>1), in which at each iteration D_{camera} (and/or D_{field_of_view}) is refined to optimize a loss function, until a convergence criterion is met. In some embodiments, the convergence criterion can define a number of iterations, a value to be reached for the loss function, etc.

In some embodiments, the convergence criterion depends on the number (e.g., absolute number or ratio) of associations/matching that have been performed between the first marine objects and the second marine objects. Indeed, the higher the number associations/matching between the first marine objects and the second marine objects, the higher the prospects that an optimal solution to the optimization problem has been found (and the better the estimation of the orientation and/or height of the imaging device).

At each iteration, it is attempted to improve the estimation of the height and/or orientation of the imaging device 120, such that the matching between the position of the first marine objects and the position of the second marine objects in the common referential is improved.

Iteration of the method can include repeating operations 221 and 222.

FIG. 2L illustrates a projection of the first position data and the second position data into a common referential 252, after N iterations of the method.

As shown, the first marine object which had an initial position 250 at the first iteration of the method, has an optimized position 255 (after N iterations of the method) which matches the position 251 of a second marine object.

Similarly, a plurality of respective first marine objects has an optimized position which now matches the position of a plurality of the respective second marine objects.

However, there can be one or more first marine objects which do not match any of the second marine objects. In FIGS. 2F and 2L, the first marine object which has position 255 at the first iteration of the method, has an optimized position 260 after N iterations of the method, which does not match any position of the second marine objects. This can be due to the fact that this marine object has been acquired only by the imaging device 120 (and not by other sensors 115), or to various factors such as noise, etc.

Attention is drawn to FIG. 2M.

As explained above (see FIG. 2B or FIG. 2D), in some embodiments, position of the first marine objects and of the second marine objects is obtained at a plurality of periods of time (set of first position data and set of second position data). This can be used to improve estimation of the height and/or orientation of the imaging device 120.

Assume that first position data and second position are obtained for time tᵢ.

The method of FIG. 2M includes projecting (operation 224) first data informative of a position of the first marine objects at time tᵢ and second data informative of a position of the second marine objects at time tᵢ into a common referential. Operation 224 is similar to operation 221.

The method further includes solving (operation 225) an optimization problem, in which data D_{camera} informative of height and/or orientation of the imaging device 120 (and/or data D_{field_of_view}) is estimated to enable matching of position of the first marine objects at time tᵢ (as recalculated using D_{camera} and the first position data) and the second position data of the second marine objects at time tᵢ.

Operation 225 is similar to operation 222.

For position data of time tᵢ, the method of FIG. 2M can be repeated iteratively (see reference 226), until a convergence criterion is met. Therefore, an estimation of the height and/or orientation of the imaging device 120 is obtained for time tᵢ.

The method can be performed again (see reference 227) at time tᵢ₊₁ (different from time tᵢ). At time tᵢ₊₁, position of the first and/or second marine objects may evolve in the common referential.

Estimation of the height and/or orientation of the imaging device 120 of time tᵢ is not necessarily valid for time tᵢ₊₁, because height and/or orientation of the imaging device 120 can change during the voyage of the marine vessel 125 (due to various factors mentioned above).

Therefore, the method can include performing operations 224 and operations 225 (these operations can be performed iteratively as depicted in reference 226), in order to estimate height and/or orientation of the imaging device 120 at time tᵢ₊₁.

In some embodiments, it is possible to use tracking of the marine objects over time to improve matching between the first marine objects and the second marine objects. In particular, if it has been determined that there is a matching between two given objects (a given object of the first marine objects and a given object of the second marine objects) at different periods of time, there is a high likelihood that the two given objects correspond to the same marine object. Therefore, at subsequent periods of time during which it is attempted to match position of the first marine objects and position of the second marine objects (operation 225), matching of the two given objects should be assigned with a high weight in the optimization problem. This can be performed by introducing a term (reward) in the loss function which takes into account this information.

A non-limitative example is provided with reference to FIG. 2N.

Assume that at time t₁ (after e.g. a plurality of iterations of the method—as depicted in reference 226), position 270 of a first marine object with tracking ID (1,1) matches a position 271 of a second marine object with tracking ID (2,1), and position 272 of a first marine object with tracking ID (1,2) matches a position 273 of a second marine object with tracking ID (2,2) in a common referential 252.

Assume that at time t₂ (after e.g. a plurality of iterations of the method), position 274 of a first marine object with tracking ID (1,1) matches a position 271 of a second marine object with tracking ID (2,1), and position 276 of a first marine object with tracking ID (1,2) matches a position 277 of a second marine object with tracking ID (2,2) in the common referential 252.

At time t₃, at the first iteration of the method, a first marine object has position 278 and tracking ID (1,1), another first marine object has position 280 and tracking ID (1,2), a second marine object has position 279 and tracking ID (2,1) and another second marine object has position 281 and tracking ID (2,2).

When trying to match the positions of the first marine objects and the second marine objects (operation 225), it is possible to take into account the tracking IDs (as illustrated in operations 285 and 286 of FIG. 2O). Indeed, it has been established at time t₁ and time t₂ that the first marine object with tracking ID (1,1) corresponds to the second marine object with tracking ID (2,1). Similarly, it has been established at time t₁ and time t₂ that the first marine object with tracking ID (1,2) corresponds to the second marine object with tracking ID (2,2).

Therefore, at time t₃, data informative of the height and/or orientation of the imaging device 120 can be estimated to attempt to match position of the first marine object with tracking ID (1,1) with position of the second marine object with tracking ID (2,1), and to attempt to match position of the first marine object with tracking ID (1,2) with position of the second marine object with tracking ID (2,2) (since there is a high likelihood that these respective positions correspond to the same respective marine object).

Matching of the first and second marine objects relies therefore not only on position, but can rely also on tracking data of the first and second marine objects over time (and/or other parameters as described hereinafter).

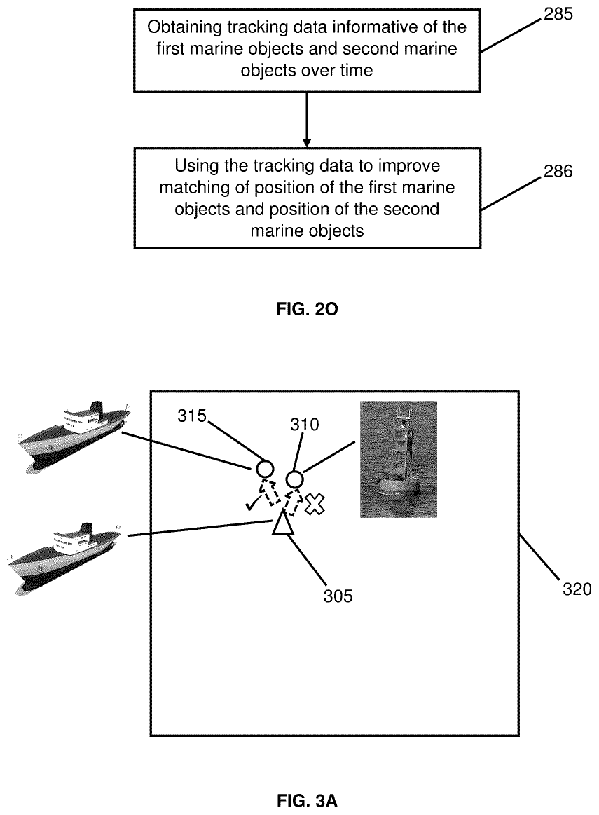

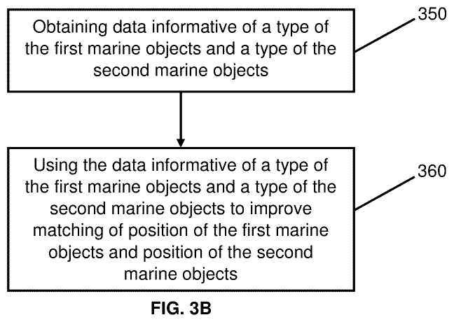

Attention is drawn to FIGS. 3A and 3B.

As mentioned above, in some embodiments, the first data informative of the first marine objects and the second data informative of the second marine objects include data informative of a type of the marine objects.

This can be used to improve matching between the first marine objects and the second marine objects.

Indeed, if it is known that two marine objects correspond to the same type of objects, a higher weight should be assigned in the optimization problem to match these two marine objects (at operations 222 or 225). This can be performed by introducing a term (reward) in the loss function which takes into account this information.

To the contrary, if two marine objects correspond to different types of objects, a low weight should be assigned in the optimization problem to match these two marine objects (at operations 222 or 225). This can be performed by introducing a term (penalty) in the loss function which takes into account this information.

A non-limitative example is shown in FIG. 3A.

Assume that a first marine object has a position 305 in the common referential 320. The first data includes type of objects and indicates that the first marine object is a marine vessel.

Assume that a second marine object has a position 315 in the common referential 320. The second data indicates that this second marine object is a marine vessel.

Assume that another second marine object has a position 310 in the common referential 320. The second data indicates that this second marine object is a buoy.

Although position 305 of the first marine object is closer to position 310 of a second marine object than to position 315 of another second marine object, the method should estimate data informative of height and/or orientation of the imaging device 120 to improve matching between position 305 of the first marine object and position 315 of a second marine object, since these two marine objects both correspond to a marine vessel (whereas the second marine object with position 310 corresponds to a buoy, which is a different marine object).

This is shown in operations 350 and 360 of FIG. 3B which illustrates using data informative of a type of the first marine objects and a type of the second marine objects to improve matching between position of the first marine objects and position of the second marine objects.

More generally, the method can use various parameters or additional input which can assist in improving the matching (or association) between the first marine objects and the second marine objects.

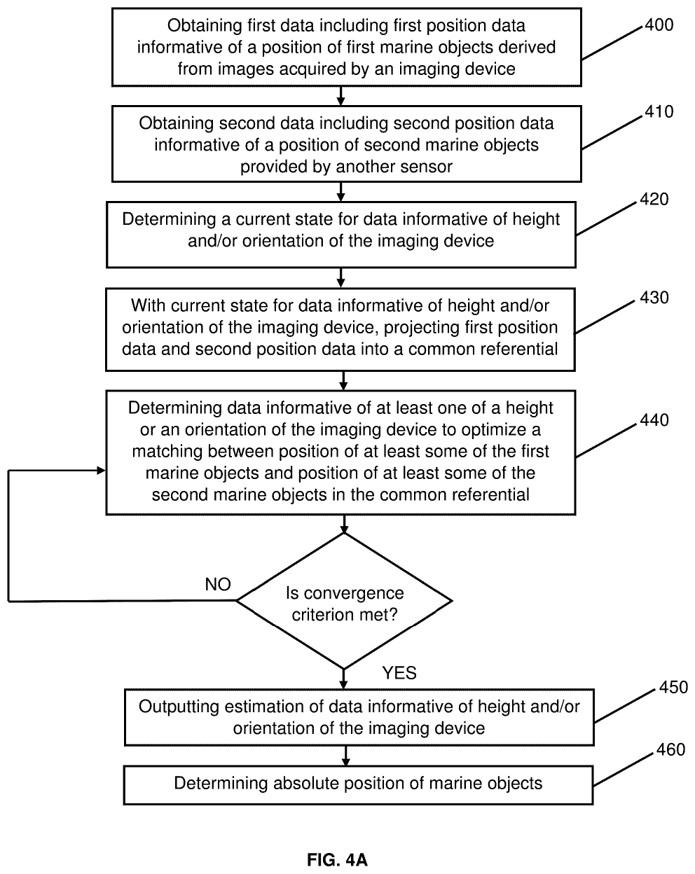

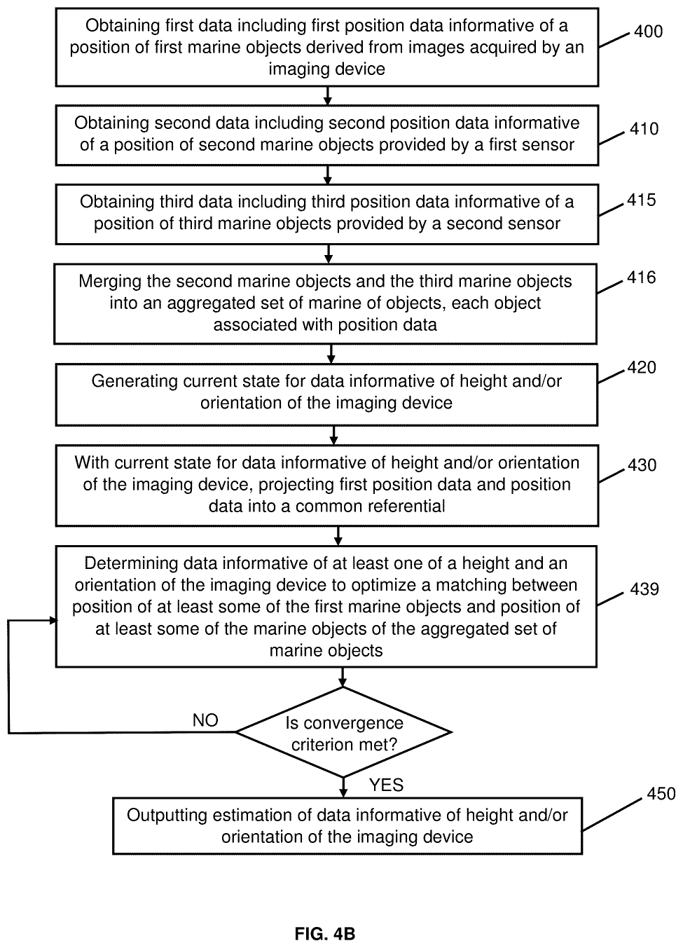

Attention is now drawn to FIG. 4A, which depicts a particular embodiment of the method of FIG. 2A.

The method includes obtaining (operation 400) first data including first position data informative of a position of first marine objects derived from images acquired by the imaging device 120. Operation 400 is similar to operation 200.

The method includes obtaining (operation 410) second data including second position data informative of a position of second marine objects provided by another sensor 115. Operation 410 is similar to operation 210. This other sensor is different from the imaging device 120, and is generally a sensor which is not a camera.

As mentioned above, at least some of the first marine objects and the second marine objects correspond to the same marine objects.

The method further includes determining (operation 420) a current state for data informative of height and/or orientation of the imaging device 120.

At the first iteration of the method, the exact height and/or orientation of the imaging device 120 is unknown. Therefore, operation 420 can include generating a random value for the height and/or orientation of the imaging device 120.

In some embodiments, a first estimation of the height and/or orientation of the imaging device 120 can be available. This first estimation can be provided e.g. by an operator and/or a manufacturer who can have first knowledge on the height and/or orientation of the imaging device 120 (e.g. due to the fact that they installed the imaging device 120 on the marine vessel 125). However, due to various factors mentioned above, this first estimation is no longer exact during voyage of the marine vessel 125, and therefore parameters of the imaging device 120 need to be estimated.

In some embodiments, a first estimation of the height and/or orientation of the imaging device 120 can be provided by an operator located on the marine vessel 125, who measures a first value of the height and/or orientation of the imaging device 120.

Once a current state is available for the height and/or orientation of the imaging device 120, first position data of the first marine objects can be projected (operation 430) into a common referential (e.g. Earth referential—this is however not limitative). An example of this projection is provided in FIG. 2G.

Similarly, the second position data can be projected into the common referential, as already explained above.

The method further includes (operation 440) determining data informative of at least one of a height or an orientation of the imaging device to optimize a matching between position of at least some of the first marine objects and position of at least some of the second marine objects.

Examples of an optimization algorithm that can be used include e.g. MSE (Mean Square error), gradient descent, MAE (mean average error), min L2 distance (Euclidean distance), etc. These examples are not limitative.

As mentioned above, operation 440 can include using various additional data to improve matching between the first marine objects and the second marine objects, such as type of marine object, tracking data of marine objects, etc.

A loss function can be calculated to reflect the optimization problem. If the loss function does not meet a convergence criterion (e.g. because its value is above a threshold), the method can be repeated, by repeating operation 440, in which it is attempted to improve estimation of the height and/or orientation of the imaging device 120, in order to improve a match between the loss function and the convergence criterion.

When the loss function of the optimization algorithm meets a convergence criterion (e.g. its value is below a threshold and/or a sufficient number of iterations has been performed), the current state (current estimation) of the height and/or orientation of the imaging device 120 can be output (operation 450). Similarly, the matching between the first marine objects and the second marine objects can be also output, for further usage, as explained hereinafter (for example, two marine objects acquired by different sensors can be considered as matching when their position in the common referential, as determined using the estimated height/orientation of the imaging device, is substantially similar, or their distance is below a threshold).

According to some embodiments, the method of FIG. 4A includes obtaining first data including first position data informative of a position of first marine objects derived from images acquired by an imaging device 120, second data including second position data informative of a position of second marine objects provided by a first sensor (see reference 115) and third data including third position data informative of a position of third marine objects provided by a second sensor (see reference 115). The first sensor and the second sensor are not imaging devices, and the first sensor can be of a different type than the second sensor. At least some of the first marine objects, the second marine objects and the third marine objects correspond to the same marine objects acquired by different sensors. In this example, the method of FIG. 4A can be performed similarly by projecting positions of all marine objects within a common referential (similar to operation 430) and attempting to determine height and/or orientation of the imaging device 120 which optimize a match between the respective positions of the first, second and third marine objects in the common referential. For example, the height and/or orientation of the imaging device is modified to force the projected position of each of the first marine objects to match, as much as possible, the position of at least one of the second and third marine objects.

It can happen that for a given marine object, it is detected only e.g. by the imaging device and the first sensor, and for another marine object, it is detected only by the first and the second sensors, or only by the imaging device and the second sensor.

As explained hereinafter, once the height and/or orientation of the imaging device 120 is estimated, this data can be used for different marine applications.

According to some embodiments, and as shown in FIG. 4A, assume that a matching between a given marine object of the first marine objects and a given marine object of the second marine objects has been found (as mentioned above, in some embodiments, this matching can be obtained after several iterations of the optimization method).

In other words, this indicates that this given marine object has been identified as the same marine object acquired both by the imaging device 120 and another sensor 115. Therefore, if the other sensor 115 provides second position data informative of the given marine object (e.g. expressed in a global/absolute referential, such as a world referential—for example, sensor 115 is an AIS), it is possible to determine (operation 460) position of the given marine object acquired by the imaging device 120 using the second position data. Attention is now drawn to FIG. 4B, which depicts a variant of the method of FIG. 4A.

The method includes obtaining (operation 400) first data including first position data informative of a position of first marine objects derived from images acquired by an imaging device 120. Operation 400 is similar to operation 200.

The method includes obtaining (operation 410) second data including second position data informative of a position of second marine objects provided by a first sensor (see reference 115). Operation 410 is similar to operation 210. This first sensor is different from the imaging device 120 and is generally a sensor which is not a camera.

The method includes obtaining (operation 415) third data including third position data informative of a position of third marine objects provided by a second sensor (see reference 115).

The second sensor is different from the first sensor and from the imaging device 120. According to some embodiments, the second sensor is not a camera.

According to some embodiments, the second sensor is of a different type than the first sensor (e.g. the first sensor is an AIS and the second sensor is a radar or a LIDAR—this is not limitative).

The method can include an intermediate operation 416, in which at least some of the second marine objects and at least some of the third marine objects are merged, to obtain an aggregated (unified) set of marine objects. This operation is however not limitative.

Each marine object of the aggregated set of marine objects is assigned with position data, which can correspond e.g. to the second position data and/or to the third position data.

Operation 416 can be performed by merging marine objects for which a distance between their positions (in a common referential) is below a threshold, and/or is minimal.

Operation 416 can include solving an optimization problem, in which it is attempted to find pairs of marine objects (each pair including a marine object of the second marine objects and a marine object of the third marine objects), such that the distance between marine objects of each pair is minimized. Optimization algorithms mentioned above can be used.

For example, assume that the first sensor is an AIS and the second sensor is a radar. An AIS provides latitude/longitude of the second marine objects, and it is possible to use the relative range/bearing measurements of the radar and position of the marine vessel 125 to determine latitude/longitude of the third marine objects. Therefore, it is possible to merge the second marine objects and the third marine objects into an aggregated set of marine objects.

Although the method of FIG. 4B is depicted with two sensors (in addition to the imaging device 120), this is not limitative, and any adapted additional sensors (which provide information on position of marine objects surrounding the marine vessel) can be used.

The method further includes, similarly to FIG. 4A, determining (operation 420) current state for data informative of height and/or orientation of the imaging device 120.

With the current state for data informative of height and/or orientation of the imaging device, the method includes projecting (operation 430) first position data into a common referential (e.g. an absolute referential, such as Earth referential).

Regarding the position data of the aggregated set of marine objects, in some embodiments, this position data is already expressed in the common referential. Indeed, if at least one given sensor (among the first sensor and the second sensor) provides position data in the common referential, then after merging of the second and third marine objects into an aggregated set of marine objects (see operation 416), it is possible to assign, to each object of the aggregated set of marine objects, position data in the common referential, as provided by the given sensor.

The method further includes determining (operation 439) data D_{camera} informative of a height and/or an orientation of the imaging device 120 to optimize a matching between position of at least some of the first marine objects determined using D_{camera} and the first position data and position of at least some of the marine objects of the aggregated set of marine objects. Operation 439 is similar to operation 440 but differs in that operation 439 includes matching between the first marine objects and the aggregated set of marine objects (obtained using at least two sensors). In some embodiments, operation 439 can include determining D_{field_of_view}.

The method can be iterated (e.g., operation 439 can be repeated to fine tune the estimation of Dcameᵣₐ) until a convergence criterion is met and there is a match between the loss function and the convergence criterion.

Once the convergence criterion is met, an estimation of the height and/or orientation of the imaging device 120 can be output (see operation 450).

As explained hereinafter, once the height and/or orientation of the imaging device 120 is estimated, this data can be used for different marine applications.

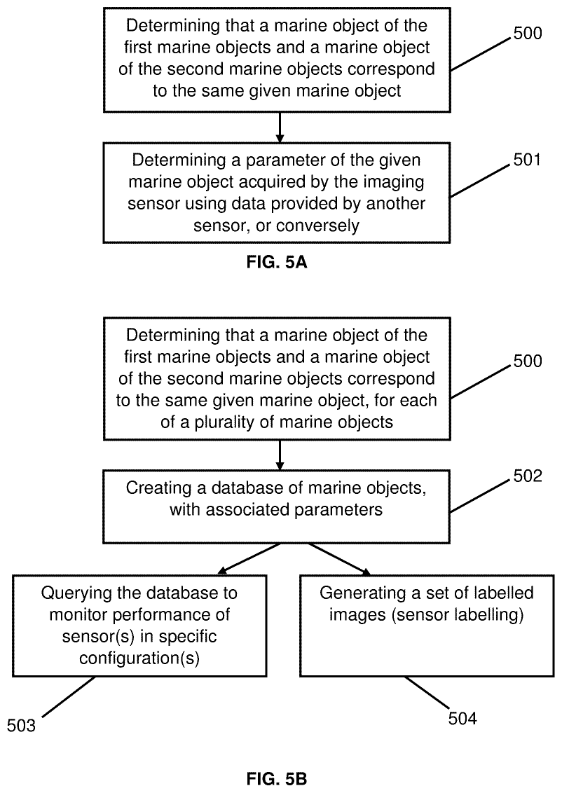

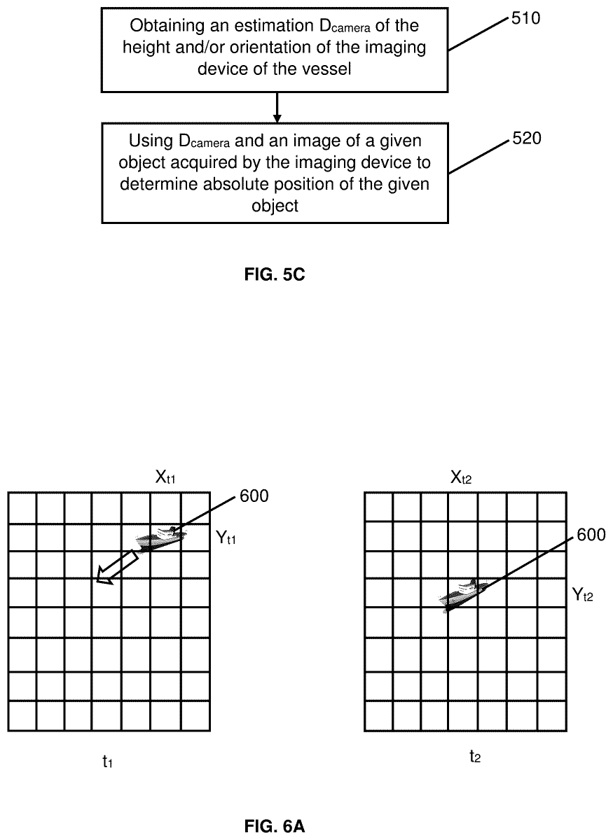

Attention is now drawn to FIG. 5A.

As explained in the various embodiments above, a matching can be performed between position of the first marine objects (acquired by the imaging device 120) and position of the second (or even third, or more) marine objects (acquired by other sensors 115).

Once this matching has been performed, it is known that a marine object of the first marine objects and a marine object of the second marine objects correspond to the same given marine object, acquired both by the imaging device 120 and the sensor(s) 115 (since their positions are substantially identical, or with a difference below a threshold). In other words, an association (operation 500) between the first marine objects and the second marine objects has been performed.

In order to augment knowledge of the given marine object, it is possible to use this association and the various parameters provided by the different sensors.

In particular, it is possible to determine (operation 501) a parameter of the given marine object, which cannot be determined using (only) the imaging device 120 but can be determined using another sensor 115 which has detected this given marine object (since it is known that the respective acquisitions by the imaging device and the at least one sensor 115 correspond to the same physical object).

Conversely, it is possible to determine a parameter of the given marine object, which cannot be determined using (only) a sensor 115 but can be determined using the imaging device 120 which has detected this given marine object (since it is known that the respective acquisitions by the imaging device and the at least one sensor 115 correspond to the same physical object).

For example, the AIS provides a type (e.g. “cargo”) of a given marine object. However, this information can be corrupted, since it is provided by the marine object itself. The imaging device can be used to determine the true type of the given marine object (using e.g., a deep neural network which detects the type of the object based on the image).

A set of augmented data/parameters can be determined for each marine object.

As a consequence, a database of marine objects (with corresponding augmented data/parameters) can be created (see operation 502) and queried, for various purposes, as explained hereinafter.

Assume that it desired to monitor performance of detection of the imaging device (or of another sensor). For each marine object, it is known whether it was detected or not, and by which sensor (since for each marine object, after the association process described in the various embodiments above, it is known which data has been acquired by each of the sensors). Performance for each sensor and for each marine object can be stored in the database. It is therefore possible to query (operation 503) the database to output performance of the imaging device (or another sensor) for specific configurations (e.g.: what is the performance of the imaging device at a distance more than 4 miles? What is the performance of the radar for cargo in rough sea, etc.). Based on this query, it is possible to attempt to improve performance of sensor(s) in specific configurations in which they underperformed. Similarly, it is possible to query the database to obtain images of marine objects with desired parameters (e.g. specific size, specific type, etc.).

Another usage of this method is depicted in FIG. 5B (see operation 504), for generating automatically labelled images of marine objects.

Assume that a sensor (e.g. AIS) of the marine vessel provides information on the type of the marine objects (e.g. “cargo”, “fishing vessel”, etc.). Therefore, for each of a plurality of marine objects detected by the imaging device, it is possible to automatically determine the type of the marine objects, as provided by the AIS (since it is known that the respective acquisitions by the imaging device and the AIS correspond to the same physical object).

As a consequence, it is possible to generate automatically a set of labelled images, which comprise the image of a marine object and a label indicative of the type of the marine object (or other/additional parameters, such as state of the sea, distance of the marine object, etc.). An automatic labelling (sensor labelling) of marine objects is therefore achieved. The labelled images can be used e.g. for supervised training of a deep neural network configured to detect marine objects in images. A training with a higher granularity is therefore achieved.

Attention is now drawn to FIG. 5C.

According to some embodiments, at least some of the marine objects encountered by the marine vessel 125 during its voyage do not have a localization system which provides their position (such as AIS, GPS, etc.). For example, an iceberg does not have a localization system.

Assume that a given marine object does not have a localization system. The given marine object may be a new object (which was not used in the method of determining height and/or orientation of the imaging device 120).

Once height and/or orientation of the imaging device 120 has been determined (operation 510—using e.g., the various methods described above), it is possible to use (operation 520) an image of the given marine object acquired by the imaging device 120, and the estimated height and/or orientation of the imaging device 120 to determine absolute position (e.g. in world coordinates) of the given marine object.

A method of converting the position of the given marine object from the referential of the image to a global/absolute position (independent from the referential of the image) has been provided e.g., with reference to FIG. 2G and can be used herein.

Similarly, it is possible to determine a distance between the marine object and the marine vessel (using e.g. the method described with reference to FIG. 2G, see e.g. “euclidean_dist”).

This is highly beneficial, since some marine objects are detected only by the imaging device 120 (for example, a fishing vessel which does not embed an AIS, and which is close to the marine vessel 125, is detected only by the imaging device 120, and not by other sensors of the marine vessel such as AIS and radar), and this method enables to determine their global/absolute position in a desired referential (or other parameters), although the parameters (D_{camera}) of the imaging device 120 evolve over time, as already explained.

It is therefore possible to determine position of a marine object (and/or distance between the marine vessel and the marine object) using only an image of the marine object acquired by the imaging device (position is determined in a referential independent of the image).

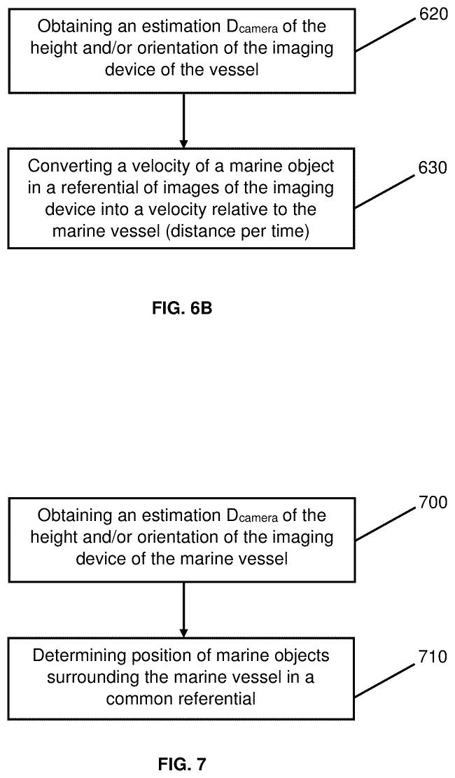

Attention is now drawn to FIGS. 6A and 6B.

When a marine object is detected over a plurality of images acquired by the imaging device 120, it is possible to track the marine objects in the plurality of images, as explained above. This is shown in FIG. 6A, in which at time t₁, marine vessel 600 is detected at position Xₜ₁, Yₜ₁ in the referential of the image.

At time t₂, marine vessel 600 is detected at position Xₜ₂, Yₜ₂ in the referential of the image.

The velocity of the marine vessel 600 relative to the marine vessel 125 can be calculated in the referential of the image (e.g. in terms of pixels per unit of time). In the example of FIG. 6A, the marine vessel 600 has moved by two pixels in a period of time “t₂−t₁”.

Since data informative of the height and/or orientation of the imaging device 120 has been estimated (operation 620—using the various methods described above), it is possible to convert (operation 630) the velocity of the marine vessel 600 in the referential of the image into a velocity of the object relative to the marine vessel (e.g. expressed in distance per unit of time). This can use a method similar to FIG. 2F to determine position in the global referential (e.g. Earth referential, which is independent from the referential of the image), and therefore velocity (which is a derivative of the position over time). In other words, it is possible to use the imaging device 120 to determine a velocity at which a marine object is moving (e.g. approaching or moving away) relative to the marine vessel 125.

In particular, it is possible to use only the imaging device 120 to determine a velocity of marine objects relative to the marine vessel 125 (expressed in distance per time relative to the marine vessel 125).

Since position of the marine object can be expressed in a global/absolute referential (e.g. Earth referential), it is possible to determine also direction of motion of the marine object over time in an absolute referential. In other words, a velocity vector can be determined in the absolute referential, using (only) data acquired by the imaging device 120.

Attention is now drawn to FIG. 7.

In order to control the trajectory of the marine vessel 125, it is beneficial to determine position of various marine objects surrounding the marine vessel 125, which can be detected by various sensors 130 of the marine vessel 125. In particular, position of the various marine objects should be expressed in a common referential (e.g. an absolute referential such as an Earth referential).

For example, it is beneficial for an operator of the marine vessel to obtain a map enabling a visualization of the position of the different marine objects surrounding the marine vessel 125. This can be helpful to facilitate control of the marine vessel during its voyage.

Similarly, the position of various marine objects surrounding the marine vessel 125 in a common referential can be used by an auto-pilot system of the marine vessel, which controls trajectory of the marine vessel overtime.

Once height and/or orientation of the imaging device 120 has been estimated (operation 700—using e.g., the methods of FIGS. 2A, 2B, 4A and 4B), it is possible to convert position of each marine object from a relative position (determined in a referential of the image acquired by the imaging device 120) into an absolute position (independent from the referential of the image, such as world coordinates). Embodiments for performing this conversion have been described above (see FIG. 2G).

Regarding other sensors 115 of the marine vessel 125, some of them provide an absolute position (such as AIS, GPS) of the marine objects.

Some of sensors 115 (which are not imaging devices) provide a relative position (such as a radar) which can be converted into an absolute position, as explained above.

Therefore, position of the marine objects acquired by the various sensors 130 of the marine vessel 125 can be expressed (operation 710) in a common referential (e.g., absolute referential).

A map of the position of the marine objects, expressed in a common referential (absolute referential), can be generated. In some embodiments, the map can include a graphical map in which position of each marine object can be depicted.

In some embodiments, type of the marine objects can be determined (e.g. using the images of the imaging device 120) or obtained (e.g. from an AIS).

The graphical map can therefore depict, for each marine object, a type of the marine object. Navigation is therefore facilitated.

Since a given marine object may be acquired by a plurality of different sensors of the marine vessel 125, in some embodiments it is possible to merge (e.g. in the map) marine objects acquired by different sensors and which have similar position (and, in some embodiments, similar type) into a single marine object with a single position. Two marine objects can be considered to share a similar position e.g. when a distance between the two marine objects is below a threshold.

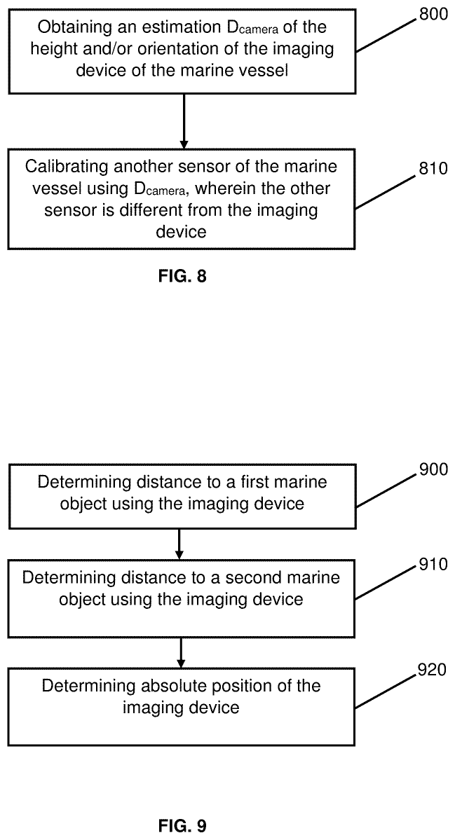

Attention is now drawn to FIG. 8.

The marine vessel 125 can include one or more sensors (different from the imaging device 120), which need to be calibrated. For example, a sensor such as IMU (Inertial Measurement Unit) has drift over time, and therefore needs to be recalibrated over time.

The method of FIG. 8 includes obtaining (operation 800) data D_{camera} informative of height and/or orientation of the imaging device 120 (estimated using e.g. the various methods described above). In some embodiments, operation 800 can include obtaining D_{field_of_view} informative of the field of view of the imaging device, as estimated using the methods described above.

The method further includes using D_{camera} to calibrate (operation 810) another sensor of the marine vessel 125, which is different from the imaging device 120. In some embodiments, the other sensor is not an imaging device, but this is not limitative. Calibration of the other sensor can include providing the “true” orientation (extracted from D_{camera}) to the other sensor to calibrate it.

In some embodiments, a plurality of other sensors can be recalibrated. In some embodiments, the calibration can use D_{field_of_view}.

In some embodiments, since D_{camera} is determined over a plurality of periods of time, it is possible to (re)calibrate the other sensor over time.

For example, IMU of the marine vessel 125 can be calibrated. IMU generally measures orientation (roll, pitch, yaw) and altitude of the marine vessel 125. Orientation and/or height of the imaging device 120 as estimated using the various methods described above can be used to calibrate orientation and/or height measured by IMU of the marine vessel 125, at a given period of time or at a plurality of periods of time.

For example, assume that the IMU and the imaging device 120 are physically aligned (e.g. they have the same orientation). During voyage of the marine vessel 125, orientation and/or height provided by IMU includes a drift, which needs to be corrected. Since orientation and/or height of the imaging device 120 can be determined (as explained in the various methods above), this can be used to recalibrate the IMU and cancel the error caused by the drift.

Although an example referring to recalibration of IMU has been provided, this applies similarly to other sensors (e.g. an experimental radar, etc.) present on the marine vessel 125, and which need to be calibrated/recalibrated. The orientation and/or height of the imaging device 120 can be used to perform the calibration/recalibration of the other sensor.

Attention is now drawn to FIG. 9.

Assume that orientation and/or height of the imaging device 120 has been estimated as explained in the various embodiments above. In some embodiments, the field of view of the imaging device has also been estimated.

The method of FIG. 9 includes using the orientation and/or height of the imaging device 120, at least one image of at least two marine objects to determine absolute position of the imaging device 120 (in some embodiments, estimation of the field of view of the imaging device can also be used).

This can include acquiring an image of a first marine object and determining (operation 900) distance to the first marine object (this can be determined using the equations provided with reference to FIG. 2F).

This can include acquiring an image of a second marine object (different from the first marine object) and determining (operation 910) distance to the second marine object (this can be determined using the equations provided with reference to FIG. 2F).

Since position of the first and second marine objects is known (e.g., because they embed a localization system such as AIS), and the distance of the marine vessel 125 to each of these marine objects has been determined, the absolute position (latitude/longitude) of the marine vessel 125 can be determined (operation 920—as an intersection of two circles). This is useful since this enables to be independent from localization systems such as GPS. This can be used also to up-sample localization data provided by the localization systems such as GPS.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A system comprising a processor and memory circuitry (PMC) configured to estimate data informative of at least one of a height or an orientation of at least one imaging device of a marine vessel, wherein at least one of the height and the orientation of the at least one imaging device is variable over time, the estimating comprising:
obtain first position data informative of a position of first marine objects, wherein the first position data is obtained based on images acquired by at least one imaging device of a marine vessel,
obtain second position data informative of a position of second marine objects, wherein the second position data is obtained based on data acquired by at least one sensor of the marine vessel, wherein the at least one sensor is different from the imaging device, wherein at least some of the first marine objects are the same as at least some of the second marine objects, and
use the first position data and the second position data to estimate data informative of at least one of a height or an orientation of the imaging device of the marine vessel.

27. The system of claim 26, wherein the orientation comprises at least one of roll, pitch and yaw of the at least one imaging device, wherein the system is configured to estimate at least one of roll, pitch and yaw of the at least one imaging device over time.

28. The system of claim 26, configured to perform at least one of (i) or (ii):
(i) estimate data informative of at least one of a height or an orientation of the at least one imaging device at a first period of time, to obtain first estimated data, and estimate data informative of at least one of a height or an orientation of the at least one imaging device at a second period of time, different from the first period of time, using the first estimated data;
(ii) estimate data informative of at least one of a height or an orientation of the at least one imaging device at a first period of time, said estimate comprising determining an association between at least some of the first marine objects and at least some of the second marine objects, and estimate data informative of at least one of a height or an orientation of the at least one imaging device at a second period of time, different from the first period of time, using said association.

29. The system of claim 26, configured to:
(1) obtain first position data informative of a position of first marine objects FIRSTMOBJ_{1,i} to FIRSTMOBJ_{N,i} at a first period of time T_{i,i}, wherein the first position data is obtained based on images acquired by the least one imaging device of the marine vessel,
(2) obtain second position data informative of a position of second marine objects SNDMOBJ_{1,i} to SNDMOBJ_{M,i} at a second period of time T_{2,i}, wherein the first period of time T_{1,i} and the second period of time T_{2,i} meet a synchronization criterion, wherein the second position data is obtained based on data acquired by the at least one sensor of the marine vessel, wherein the at least one sensor is different from the imaging device, wherein at least some of the first marine objects FIRSTMOBJ_{1,i} to FIRSTMOBJ_{N,i} are the same as at least some of the second marine objects SNDMOBJ_{1,i} to SNDMOBJ_{M,i},
(3) use the first position data and the second position data to estimate data informative of at least one of a height or an orientation of the at least one imaging device of the marine vessel, and
(4) repeat (1), (2) and (3) for i incremented by one, wherein a first period of time T_{1,i+1} differs from T_{1,i} and a second period of time T_{1,i+1} differs from T_{2,i}, for repetitively estimating data informative of at least one of a height or an orientation of the imaging device of the marine vessel over time.

30. The system of claim 26, wherein at least one of (i), (ii) and (iii) is met:
(i) the at least one sensor is not an imaging device;
(ii) the at least one sensor includes at least one of a radar and an automatic identification system (AIS);
(iii) the at least one sensor includes a first sensor and a second sensor, wherein the second sensor is of a different type than the first sensor, and wherein the first sensor and the second sensor are not imaging devices.

31. The system of claim 26, wherein using the first position data and the second position data comprises determining data D_{camera} informative of at least one of a height or an orientation of the imaging device which optimize a matching between:
position of at least some of the first marine objects determined using D_{camera} and the first position data, and
second position data of at least some of the second marine objects according to a criterion.

32. The system of claim 26, configured to use the first position data and the second position data to determine data D_{field_of_view} informative of a field of view of the imaging device which optimize a matching between:
position of at least some of the first marine objects determined using D_{field_of_view} and the first position data, and
second position data of at least some of the second marine objects, according to a criterion.

33. The system of claim 26, wherein (i) or (ii) is met:
(i) the system is configured to obtain a set of first position data informative of a position of first marine objects, wherein the set of first position data is obtained based on images acquired by the at least one imaging device of the marine vessel, wherein the set of first position data comprises, for each object of a plurality of the first marine objects, a position of the object at a plurality of first periods of time,
obtain a set of second position data informative of a position of second marine objects,
wherein the set of second position data comprises, for each object of a plurality of the second marine objects, a position of the object at a plurality of periods of time,
wherein the first periods of time and the second periods of time meet a synchronization criterion,
wherein the set of second position data is obtained based on data acquired by at least one sensor of the marine vessel,
wherein the at least one sensor is different from the imaging device, wherein at least some of the first marine objects are the same as at least some of the second marine objects, and
use the first set of position data and the second set of position data to estimate data informative of at least one of a height or an orientation of the imaging device over time;
(ii) the system is configured to obtain a set of first position data informative of a position of first marine objects, wherein the set of first position data is obtained based on images acquired by the at least one imaging device of the marine vessel, wherein the set of first position data comprises, for each object of a plurality of the first marine objects, a position of the object at a plurality of first periods of time,
obtain a set of second position data informative of a position of second marine objects,
wherein the set of second position data comprises, for each object of a plurality of the second marine objects, a position of the object at a plurality of periods of time,
wherein the first periods of time and the second periods of time meet a sychchronization criterion,
wherein the set of second position data is obtained based on data acquired by at least on e sensor of the marine vessel,
wherein the at least one sensor is different from the imaging device, wherein at least some of the first marine objects are the same as at least some of the second marine objects,
use the first et of position data and the second set of position data to estimate data informative of at least one of a height or an orientation of the imaging device over time,
track position of at least some of the first marine objects at the first periods of time and position of at least some of the second marine objects at the second periods of time, and
use said tracking to estimate data D_{camera} informative of at least one of a height of an orientation of the imaging device which optimize a matching between a position of at least some of the first marine objects determined using D_{camera} and the set of the first position data, and a position of the second marine objects obtained based on the second set of position data.

34. (canceled)

35. The system of claim 26, wherein (i) or (ii) is met:
(i) the system is configured to obtain first position data informative of a position of first marine objects, wherein the first position data is obtained based on images acquired by at least one imaging device of a marine vessel,
obtain second position data informative of a position of second marine objects,
wherein the second position data is obtained based on data acquired by at least one first sensor of the marine vessel, wherein the at least one first sensor is different from the imaging device,
obtain third position data informative of a position of third marine objects,
wherein the third position data is obtained based on data acquired by at least one second sensor of the marine vessel, wherein the at least one second sensor is different from the imaging device and from the first sensor,
wherein at least some of the first, second and third marine objects are the same marine objects,
use the first position data, the second position data and the third position data to estimate data informative of at least one of a height or an orientation of the imaging device of the marine vessel;
(ii) the system is configured to obtain first position data informative of a position of first marine objects, wherein the first position data is obtained based on images acquired by at least one imaging device of marine vessel, obtain second position data informative of a position of second marine objects, wherein the second position data is obtained based on data acquired by at least one first sensor of the marine vessel, wherein the at least one first sensor is different from the imaging device, obtain third position data informative of a position of third marine objects, wherein the third position data is obtained based on data acquired by at least one second sensor of the marine vessel, wherein the at least one second sensor is different from the imaging device and fro the first sensor, wherein tat least some of the first, second and third marine objects are the same marine objects, use the first position data the second position data and the third position data to estimate data informative of at least one of a height or an orientation of the imaging device of the marine vessel, and associate at least some of the second marine object with at least some of the third marine objects to generate an aggregated set of marine objects, each associated with a position provided by the first sensor or the second sensor.

36. The system of claim 26, wherein at least one (i) or (ii) is met:
(i) the system is configured to determine data D_{camera} informative of at least one of a height or an orientation of the imaging device which optimize a matching between position of at least some of the first marine objects projected in a common referential using D_{camera} and the first position data, and position in the common referential of at least some of the second marine objects according to a criterion,
(ii) the system is configured to iteratively estimate data informative of at least one of a height of an orientation of the imaging device for a given period of time, until a convergence criterion is met.

37. (canceled)

38. The system of claim 26, configured to:
determine that a marine object of the first marine objects and a marine object of the second marine objects correspond to a same given marine object acquired respectively by the imaging device and the at least one sensor,
determine a parameter of the given marine object using data provided by the at least one sensor, or determine a parameter of the given marine object using data provided by the imaging device.

39. The system of claim 26, wherein at least one of (i) or (ii) is met:
(i) the system is configured to determine a position of at least one given object of the first marine objects acquired by the imaging device based on second position data of a given object of the second marine objects, wherein a matching between the given object of the first marine objects and the given object of the second marine objects has been determined based on at least part of the first position data and the second position data;
(ii) estimating data informative of at least one of a height or an orientation of the imaging device comprises using data informative of a type of the first marine objects and data informative of a type of the second marine objects to determine a matching between at least some of the first marine objects and at least some of the second marine objects.

40. (canceled)

41. The system of claim 26, wherein at least one (i) or (ii) is met:
(i) The system is configured to use data informative of at least one of a height or an orientation of the imaging device as estimated and an image of a marine object acquired by the imaging device to determine data informative of a position of the marine object in a referential independent of the image, or data informative of a distance between the marine object and the marine vessel;
(ii) the marine object is acquired by the imaging device of the marine vessel, but is not detected by any of the other sensors present in the marine vessel, wherein said other sensors are not imaging devices.

42. (canceled)

43. The system of claim 26, configured to use data informative of at least one of a height or an orientation of the imaging device as estimated to output a position of a marine object as acquired by the imaging device and a position of another marine object acquired by the other sensor in a common referential.

44. The system of claim 26, configured to use data informative of at least one of a height or an orientation of the imaging device as estimated, and images of the marine object acquired by the imaging vessel, to determine a velocity of the marine object relative to the marine vessel.

45. The system of claim 26, configured to use data informative of at least one of a height or an orientation of the imaging device as estimated to calibrate another sensor of the marine vessel, different from the imaging device.

46. The system of claim 26, wherein (i), (ii) or (iii) is met:
(i) the PMC is configured to, for each of a plurality of first given marine objects of the first marine objects and second given marine objects of the second marine objects:
determine that the first given marine object and the second given marine object correspond to a same given marine object of a plurality of given marine objects acquired by the imaging device and the at least one sensor,
generate a dataset of a plurality of labelled images, wherein each labelled image comprises an image of a given marine object of said plurality of given marine objects, and a label;
(ii) the PMC is configured to, for each of a plurality of first given marine objects of the first marine objects and second given marine objects of the second marine objects:
determine that the first given marine object and the second given marine object correspond to a same given marine object of a plurality of given marine objects acquired by the imaging device and the at least one sensor,
generate a dataset of a plurality of labelled images, wherein each labelled image comprises an image of a given marine object of said plurality of given marine objects, and a label determined by the PMC based on data provided by at least one of the imagine device and the at least one sensor;
(ii) the PMC is configured to, for each of a plurality of first given marine objects of the first marine objects and second given marine objects of the second marine objects,
determine that the first given marine object and the second given marine object correspond to a same given marine object of a plurality of a given marine objects acquired by the imaging device and the at least one sensor,
generate a database comprising for each of said plurality of given marine objects, data informative of said plurality of given marine objects, and data informative of performance of detection of said plurality of given marine objects by at least one of the imaging device and the at least one sensor.

47. (canceled)

48. A non-transitory computer readable medium comprising instructions that, when executed by one of more processing circuitries, cause the one or more processing circuitries to estimate data informative of at least one of a height or an orientation of at least one imaging device of a marine vessel, wherein at least one of the height and the orientation of the at least one imaging device is variable over time, the estimating comprising:
obtaining first position data informative of a position of first marine objects, wherein the first position data is obtained based on images acquired by at least one imaging device of a marine vessel,
obtaining second position data informative of a position of second marine objects,
wherein the second position data is obtained based on data acquired by at least one sensor of the marine vessel, wherein the at least one sensor is different from the imaging device, wherein at least some of the first marine objects are the same as at least some of the second marine objects, and
using the first position data and the second position data to estimate data informative of at least one of a height or an orientation of the at least one imaging device of the marine vessel.

49. The system of claim 26, embedded on said marine vessel comprising said
at least one imaging device and said
at least one sensor different from said at least one imaging device.

50. A non-transitory computer readable medium comprising instructions that, when executed by one of more processing circuitries, cause the one or more processing circuitries to:
obtain first position data informative of a position of first marine objects, wherein the first position data is obtained based on images acquired by at least one imaging device of a marine vessel,
obtain second position data informative of a position of second marine objects,
wherein the second position data is obtained based on data acquired by at least one sensor of the marine vessel, wherein the at least one sensor is different from the imaging device,
wherein at least some of the first marine objects are the same as at least some of the second marine objects,
determine a match between at least some of the first marine objects and at least some of the second marine objects using the first position data and the second position data, and
generate a database informative of at least some of the first marine objects and the second marine objects using:
said match, and
data informative of the first marine objects and the second marine objects, determined based on data provided by at least one of the imaging device and the at least one sensor.
